(19) United States
(12) Patent Application Publication
(10) Pub. No.: US 2006/0081761 A1
(43) Pub. Date: Apr. 20, 2006

(54) Optical pickup apparatus and optical disk apparatus

(75) Inventors: Hiroshi Tanigawa, Kumamoto-shi (JP); Eizo Ono, Kikuchi-shi (JP); Mitsuhiro Matsumoto, Arao-shi (JP); Toshihiro Koga, Kikuchi-gun (JP); Masaharu Fukakusa, Kobayashi-shi (JP); Jiro Mimasa, Tamana-shi (JP); Akihiro Imayoshi, Kikuchi-gun (JP); Minoru Fujita, Kamoto-gun (JP); Takeshi Fujishima, Kikuchi-gun (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/249,766

(22) Filed: Oct. 14, 2005

(30) Foreign Application Priority Data
Oct. 15, 2004 (JP) P2004-301168
Oct. 26, 2004 (JP) P2004-310509
Jun. 22, 2005 (JP) P2005-181958

(51) Int. Cl. G02B 27/40

(52) U.S. Cl. 250/201.5

(57) ABSTRACT

An optical pickup apparatus, comprises: a light source in which a plurality of light emitting points having different wavelengths are provided; a light receiving unit, receiving light reflected from an optical disk to produce an electric signal; and an optical system, collecting light emitted from the respective light emitting points to the optical disk and conducting the light reflected from the optical disk to the light receiving unit; wherein the optical system includes a filter which converts the light emitted from the respective light emitting points into a predetermined optical intensity distribution.

### BACKGROUND OF THE INVENTION

1. Field of the Invention

The present invention is related to both an optical pickup apparatus suitably provided in an optical disk apparatus mounted on an electronic appliance such as a personal computer and a notebook type computer, and also related to an optical disk apparatus.

2. Description of the Related Art

Conventionally, as optical recording media, various sorts of optical disks such as DVDs (Digital Versatile Disks), CD-R (Writable Compact Disks), and CD-RW (Rewritable Compact Disks) have been developed. In DVDs, information is recorded, or reproduced by using laser light having a wavelength of approximately 650 nm. On the other hand, in CD-R and CD-RW, information is recorded, or reproduced by using laser light having a wavelength of approximately 780 nm. With respect to such plural sorts of optical disks, optical disk apparatus have been proposed which can record, or reproduce information.

Also, in these optical disk apparatus for recording, or reproducing information with respect to the plural sorts of optical disks, a semiconductor laser in which laser elements having a plurality of different wavelengths are arranged adjacent to each other in a single package (so-called “hybrid type two-wavelength semiconductor laser”, another semiconductor laser in which optical sources having a plurality of wavelengths are integrated on a single semiconductor substrate (so-called “monolithic type two-wavelength semiconductor laser”), and the like have been proposed. Optical systems which employ these two-wavelength semiconductor lasers may have such a merit of cost down effects with respect to optical systems which employ plural optical sources in correspondence with the respective wavelengths, since optical components which have been separately set can be commonly utilized.

However, in these two-wavelength semiconductor lasers, a distance between light emitting points of the two wavelengths is about 110 μm in case of any of the hybrid type semiconductor laser and the monolithic type semiconductor laser, so that optical axes of the two light sources are necessarily and optically shifted. As a consequence, as described in, for instance, Japanese Laid-open Patent Application No. 2000-99983, since the parallel flat plate is employed on which the film having the wavelength selective characteristic has been formed, the optical paths as to two sets of the laser light with two different wavelengths are made coincident with each other.

Otherwise, as described in Japanese Laid-open Patent Application No. 2001-148136, the optical system is arranged in such a manner that the two-wavelength semiconductor laser is properly arranged so as to reduce aberration of light emitted from such a light source which can hardly achieve predetermined performance at a top priority. Also, as indicated in Japanese Laid-open Patent Application No. 2002-25103, such a light source which can hardly achieve predetermined performance is made coincident with the optical axis of the optical system.

FIG. 28 is a schematic diagram for showing an optical system of a conventional optical pickup apparatus. It should be understood that for the sake of simple explanations, both a return-path optical system for detecting light returned from an optical disk, and a monitor optical system for controlling a light amount are omitted. Also, the optical system shown in FIG. 28 represents that the optical system shown in FIG. 28 represents that the optical structures described in the above-explained three Japanese patent publications are combined with each other. A two-wavelength semiconductor laser light source 1 is provided with a light emitting point 2 having a wavelength “λ1” (650 nm) for a DVD purpose, and a light emitting point 3 having a wavelength “λ2” (780 nm) for a CD purpose. The light emitting point 2 having the wavelength “λ1,” which can hardly achieve predetermined performance is made coincident with an optical axis of the optical system in order to reduce aberration at a top priority. Also, a parallel flat plate 31 is constituted by a first wavelength selective film 31a, a substrate 31b, a second wavelength selective film 31c, and a thick substrate 31d. The first wavelength selective film 31a reflects light having a wavelength “λ1”, and also penetrates therethrough light having a wavelength “λ2.” The substrate 31b penetrates therethrough light. The second wavelength selective film 31c reflects thereon the light having the wavelength “λ2. ” An optical path of the laser light having the wavelength “λ1” is made coincident with an optical path of the laser light having the wavelength “λ2” by adjusting the thickness of the substrate 31b and an incident angle of laser light. Also, a collimator lens 6 converts the light emitted from the light emitting point 2 and the light emitted from the light emitting pint 3 into substantially parallel light, and an objective lens 11 collects the substantially-parallel converted light onto an optical disk 12.

Very recently, such demands are gradually made in optical disk apparatus by which not only reproducing operation, but also recording operation may be performed in DVDs, and recording operation may be carried out in higher double speeds in CDs. In order to not only reproduce, but also record information from/on DVDs, diameters of collected light spots on optical disks must be narrowed, so that optical magnification must be increased. On the other hand, in order to realize that information is recorded on CDs in higher double speeds, the optical magnification must be suppressed to low optical magnification for such a purpose that a utilization efficiency of laser light is kept high. However, in the conventional optical system structure using the two-wavelength semiconductor laser, since the light emitting points are located in proximity to each other, such operations that not only the reproducing operation, but also the recording operation are carried out in DVDs is not compatible with such an operation that the recording operation is carried out in the higher double speeds in CDs.

### SUMMARY OF THE INVENTION

The present invention has been made to solve the above-described problems of the prior art, and therefore, has an object to provide an optical pickup apparatus equipped with an optical source in which a plurality of light emitting points having different wavelengths are provided in proximity to each other, and the optical picking apparatus capable of performing both a recording operation and a reproducing operation in higher double speeds even by using light emitted from the light emitting points having any of these different wavelengths.

In order to solve the above-explained conventional problem, an optical pickup apparatus, according to the present invention, is featured by comprising: a light source in which a plurality of light emitting points having different wavelengths are provided; a light receiving means for receiving light reflected from an optical disk to produce an electric signal; and an optical system for collecting light emitted from the respective light emitting points to the optical disk, and for conducting the light reflected from the optical disk to the light receiving means; in which the optical system includes a filter which converts the light emitted from the respective light emitting points into a predetermined optical intensity distribution. The optical intensity distribution of the light emitted from each of the light emitting points is converted into a predetermined intensity distribution, so that both a diameter of a light collective spot on the optical intensity distribution can be converted into an optimum spot and an optimum optical intensity distribution.

As previously explained, the optical pickup apparatus of the present invention can convert the diameter of the light collective spot on the optical disk and the optical intensity distribution into the optimum diameter and the optimum optical intensity distribution with respect to each of the light having the respective different wavelengths. As a result, any light emitted from any light emitting points having these different wavelengths can be used in both the recording operation and the reproducing operation in higher double speeds.

### BRIEF DESCRIPTION OF THE DRAWINGS

FIG. 1 is a schematic diagram for showing an optical system of an optical pickup apparatus according to an embodiment mode 1.

FIG. 2(a) is an upper view for showing a filter portion of the embodiment mode 1 in an enlarging manner, and FIG. 2(b) is a front view thereof FIG. 3 is a diagram for indicating such a condition that a film of the filter portion of the embodiment mode 1 is formed.

FIG. 4 is a diagram for indicating a relationship between luminous flux and a region where a total reflecting film of the filter portion of the embodiment mode 1 is not formed.

FIG. 5(a) is an upper view for showing the optical pickup apparatus of the embodiment mode 1, and FIG. 5(b) is a lower view thereof.

FIG. 6 is a sectional view for showing the optical pickup apparatus, taken along a line A-A of FIG. 5(a).

FIG. 7(a) is a diagram for comparing optical intensity distributions with each other in case that the filter is present, or not present on an aperture plane of an objective lens, and FIG. 7(b) is a diagram for comparing optical intensity distributions with each other in case that the filter is present, or not present on an optical disk.

FIG. 8 is a schematic diagram for showing an optical system of an optical pickup apparatus according to an embodiment mode 2.

FIG. 9 is a diagram for showing a filter portion of the embodiment mode 2 in an enlarging manner.

FIG. 10 is a perspective view for indicating an optical disk apparatus according to an embodiment mode 3.

FIG. 11 is a schematic diagram for indicating an optical system of an optical pickup according to an embodiment mode 4.

FIG. 12 is a schematic structural diagram for representing an entire optical system of an optical pickup apparatus using a two-wavelength semiconductor laser of the embodiment mode 5.

FIG. 13(a) is an upper view for showing the two-wavelength semiconductor laser and a diffraction grating according to the embodiment mode 5 in the enlarging manner, FIG. 13(b) is a side view thereof, and FIG. 13(c) is a front view thereof.

FIG. 14 is an arranging diagram for showing a light receiving unit of a light receiving sensor of the embodiment mode 5.

FIG. 15(a) is a schematic diagram for showing a light amount distribution on an optical disk in the conventional optical pickup apparatus, and FIG. 15(b) is a schematic diagram for showing a light amount distribution on an optical disk in the optical pickup apparatus according to the embodiment mode 5.

FIG. 16(a) is an upper view for showing the two-wavelength semiconductor laser and a diffraction grating according to an embodiment mode 6 in the enlarging manner, FIG. 16(b) is a side view thereof, and FIG. 16(c) is a front view thereof.

FIG. 17 is a perspective view for showing an optical disk apparatus according to an embodiment mode 7.

FIG. 18 is an exploded perspective view for showing a laser light source module according to an embodiment mode 8.

FIG. 19 is a structural perspective view for showing the laser light source module according to the embodiment mode 8.

FIG. 20(a) is a structural diagram for indicating a front plane of a laser light source according to the embodiment mode 8, and FIG. 20(b) is a structural diagram for showing a rear plane thereof.

FIG. 21(a) is a perspective view for indicating a rear plane of a coupling base according to the embodiment mode 8, and FIG. 21(b) is a perspective view for showing a front plane thereof.

FIG. 22(a) is a structural diagram for indicating an optical element according to the embodiment mode 8, and FIG. 22(b) is a structural diagram for showing the optical element thereof.

FIG. 23(a) is a structural diagram for indicating a light receiving element according to the embodiment mode 8, and FIG. 23(b) is a structural diagram for showing a light receiving element thereof.

FIG. 24 is a structural diagram for indicating an optical system of an optical pickup according to an embodiment mode 9.

FIG. 25(a) is an exploded structural diagram for showing an optical pickup according to an embodiment mode 9, and FIG. 25(b) is an assembled structural diagram thereof.

FIG. 26 is a structural diagram for showing a driving mechanism of an optical disk apparatus according to an embodiment mode 10.

FIG. 27 is a structural diagram for showing the optical disk apparatus according to the embodiment mode 10.

FIG. 28 is a schematic diagram for showing the optical system of the conventional optical pickup apparatus.

### DESCRIPTION OF THE PREFERRED EMBODIMENTS

### Embodiment Mode 1

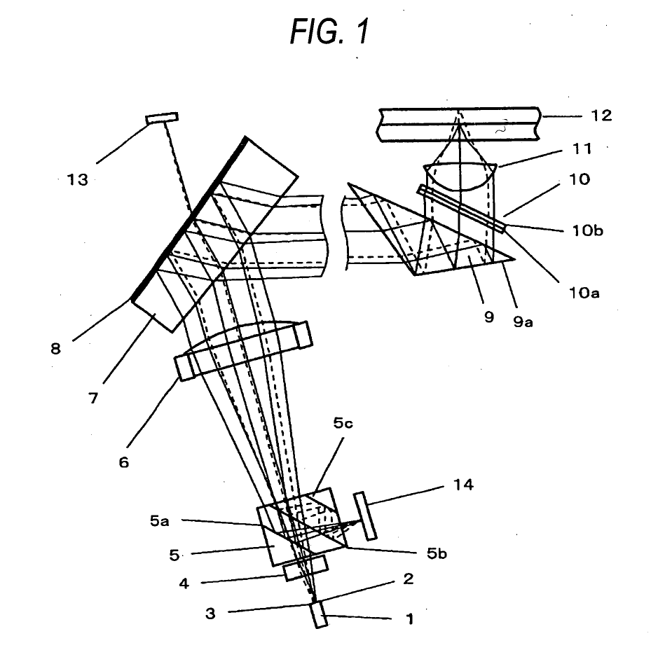

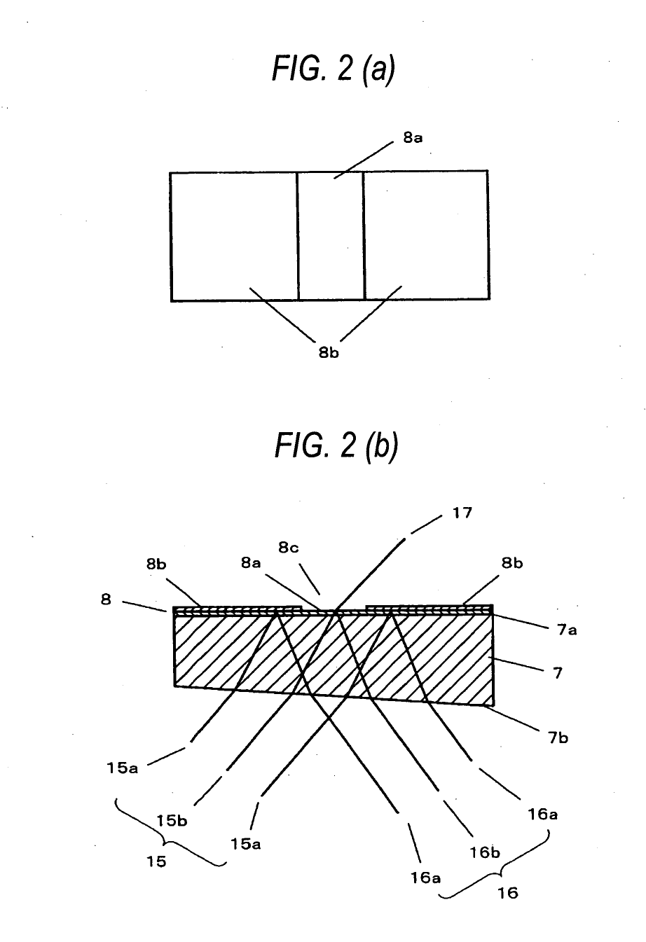

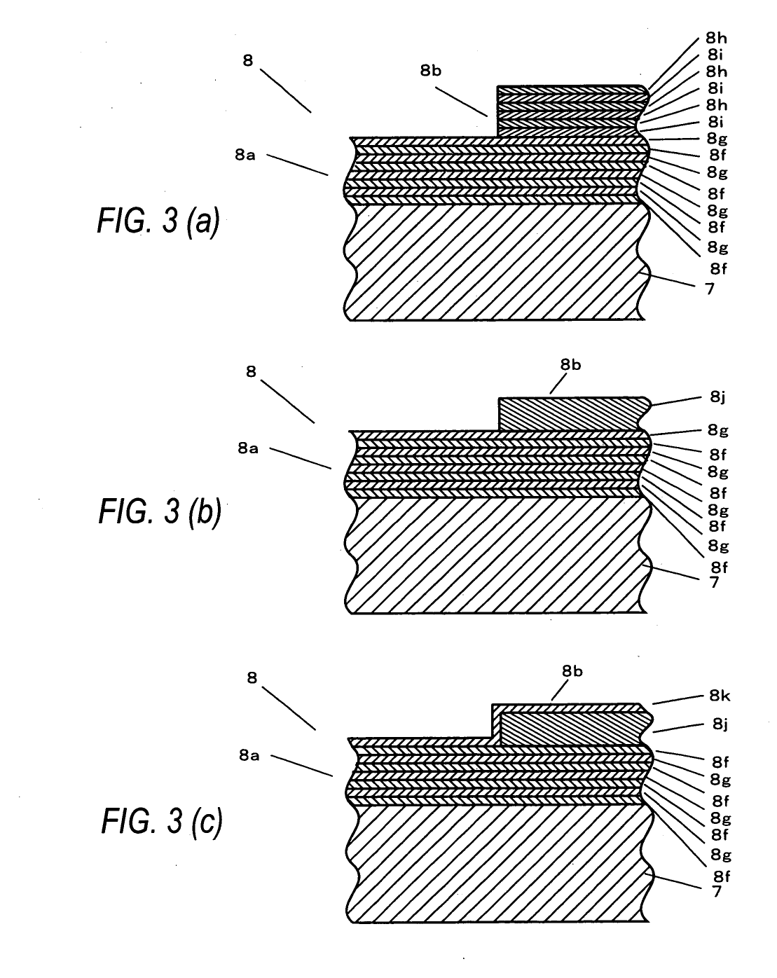

An optical pickup apparatus according to an embodiment mode 1 of the present invention will now be described with reference to drawings. FIG. 1 is a schematic diagram for showing an optical system of the optical pickup apparatus according to the embodiment mode 1 of the present invention. FIG. 2(a) is an upper view for showing an enlarged filter unit of this embodiment mode 1, and FIG. 2(b) is a front view for indicating the enlarged filter unit.

FIG. 3 is a diagram for indicating a forming condition under which films of the filter unit of the embodiment mode 1 are formed; FIG. 3(a) indicates such a case that a total reflecting film corresponds to a dielectric multilayer film; FIG. 3(b) indicates such a case that a total reflecting film corresponds to a metal film; and FIG. 3(c) indicates such a case that a total reflecting film corresponds to a metal film, and also, a protection layer of the metal film is provided which may also function as the last one layer of a wavelength selective polarized light separating film.

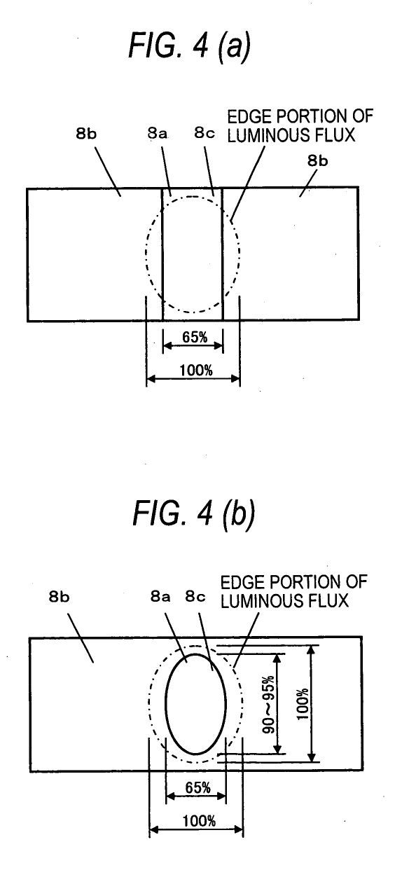

Furthermore, FIG. 4 is a diagram for showing a relationship between luminous flux and an area where the total reflecting film of the filter unit of this embodiment mode 1 is not formed; FIG. 4(a) indicates such a case that the area where the total reflecting film is not formed corresponds to a shape of long strip paper; and FIG. 4(b) indicates such a case that the area where the total reflecting film is not formed corresponds to an ellipse shape.

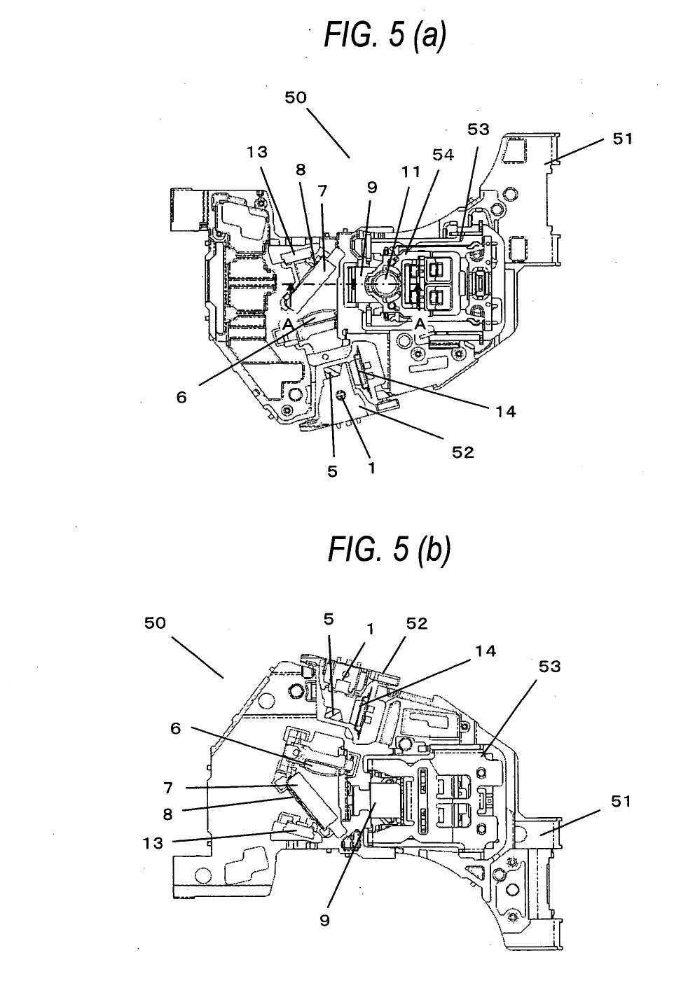

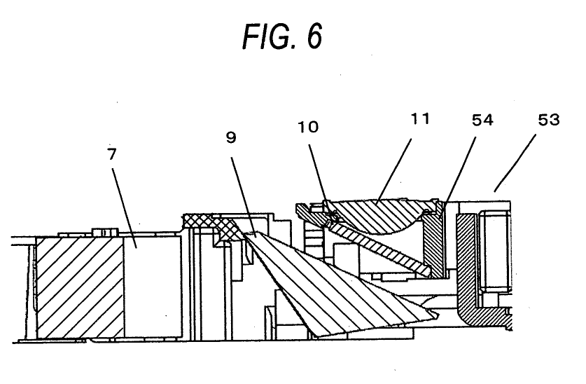

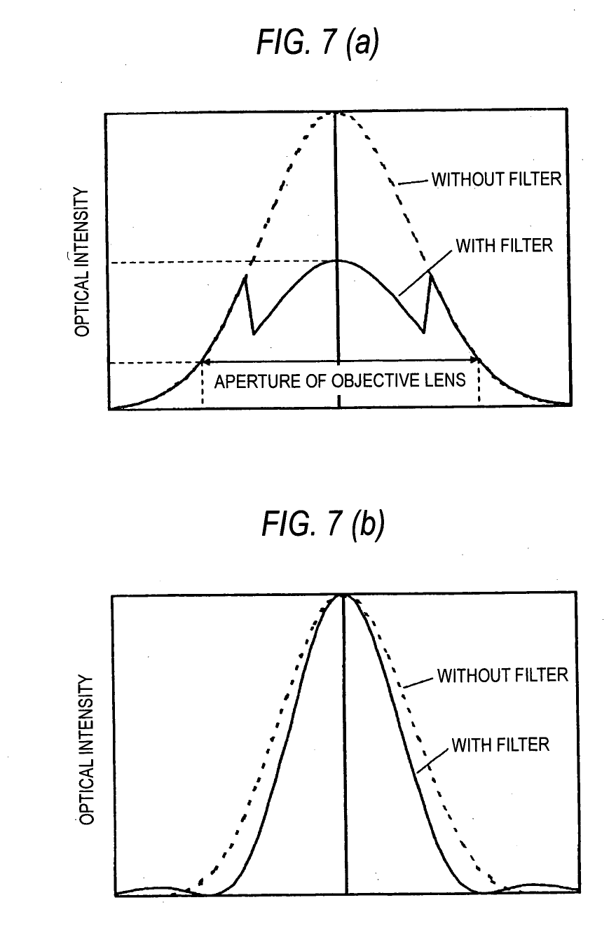

Also, FIG. 5(a) is an upper view for indicating the optical pickup apparatus of this embodiment mode 1, FIG. 5(b) is a lower view for representing the optical pickup apparatus. FIG. 6 is a sectional view of the optical pickup apparatus, taken along a line A-A of FIG. 5(a). FIG. 7(a) is a graphic diagram for comparing optical intensity distributions with each other in such a case that a filter is present, or not on an aperture plane of an objective lens; and FIG. 7(b) is a graphic diagram for comparing optical intensity distributions with each other in such a case that a filter is present, or not on an optical disk.

First, a structure of the optical pickup apparatus will now be explained. As shown in FIG. 1, a two-wavelength semiconductor laser light source 1 corresponding to such a light source that a plurality of light emitting points having different wavelengths are provided in proximity to each other is equipped with both a light emitting point 2 having a wavelength “λ1 (650 nm)” for a DVD use, and another light emitting point 3 having a wavelength “λ2 (780 nm)” for a CD use. It should be understood that the two-wavelength semiconductor laser light source 1 may be constituted by a so-called “hybrid type two-wavelength semiconductor laser”, or a so-termed “monolithic type two-wavelength semiconductor laser.” Alternatively, this two-wavelength semiconductor laser light source 1 may be constituted by a light source equipped with light emitting points having three, or more wavelengths. Also, an interval between the light emitting point 2 and the light emitting point 3 is selected to be approximately 0.05 mm to approximately 0.15 mm. In this embodiment mode 1, such a monolithic type two-wavelength semiconductor laser that an interval between light emitting points having two wavelengths is approximately 110 μm has been employed. A diffraction grating 4 corresponds to such a diffraction grating which has been formed on either a surface or an inner portion of an optical member. This diffraction grating 4 separates light emitted from the light emitting point 3 into three sets of light which are used in a three-beam tracking method. An integrated prism 5 has been constituted by such an optical member that a plurality of inclined planes 5a to 5c have been provided in an internal portion thereof, while polarized light separating films (not shown in detail) have been formed on these inclined planes 5a to 5c in response to wavelengths.

Furthermore, a collimator lens 6, and an objective lens 11 corresponding to a two-focal-point objective lens have been manufactured by employing either optical glass or optical plastic. The light emitted from the light emitting point 2 and the light emitted from the light emitting point 3 are converted by the collimator lens 6 into substantially parallel light beams, and then, these substantially parallel light beams are collected by the objective lens 11 in such a manner that these light beams are focused at positions of an optical disk 12 in correspondence with the respective wavelengths thereof. In this embodiment mode 1, it should be understood that both a line and an extended line thereof, which connect a center of this collimator lens 6 to a center of the objective lens 11, are referred to as an optical axis of the optical system. As the two-focal-point objective lens 11, such a combined lens may be employed, namely, a lens manufactured by combining a collective lens with either a Fresnel lens or a hologram lens; a lens manufactured by providing an aperture limiting means on a DVD-purpose collective lens when a CD is reproduced; and the like.

An optical transmission member 7 has been manufactured by either optical glass or optical plastic. As shown in FIG. 2(a), or FIG. 2(b), a filter 8 is formed on a plane 7a which is not located opposite to the light emitting point 2 and the light emitting point 3 of the optical transmission member 7. The optical transmission member 7 comprises the plane 7a, and another plane 7b which is located opposite to the light emitting point 2 and the light emitting point 3. The plane 7a and the plane 7b are positioned by setting an angle of, for example, approximately 1.1 degrees so as not to be located parallel to each other in such a manner that light which has passed through the optical transmission member 7 does not interfere with each other. Furthermore, the optical axis, and both the plane 7a and the plane 7b which are located perpendicular to the plane which is constructed of the light emitting point 2 and the light emitting point 3 are not located parallel to each other, namely non-parallel, so that astigmatism of the light emitted from the light emitting point 2 and the light emitting point 3 which are not located on the optical axis of the optical system can be decreased. On the other hand, if these interference and astigmatism of the light do not cause any problem, then reductions of manufacturing cost when the plane 7a and the plane 7b are located parallel to each other may be realized.

The filter 8 has been equipped with a wavelength selective polarized light separating film 8a formed on the plane 7a of the optical transmission member 7, and a total reflecting film 8b. This total reflecting film 8b has been formed on a surface of the wavelength selective polarized light separating film 8a in correspondence with a predetermined optical intensity distribution. The wavelength selective polarized light separating film 8a is manufactured by a dielectric multi-layer film. In this wavelength selective polarized light separating film 8a, 28 to 48 layers of both high refractive index films 8f and low refractive index films 8g are alternately stacked with each other. As the high refractive index film 8f, there are TiO₂, Nb₂O₅, Ta₂O₅, Al₂O₃, and the like. Also, as the low refractive index film 8g, there are SiO₂, MgF₂, and the like. Thickness of the respective films is 100 to 200 nm. A reflectance factor of the wavelength selective polarized light separating film 8a corresponds to a reflectance factor of stacked layer made of the high refractive index film 8f and the low refractive index film 8g. The film characteristic of the wavelength selective polarized light separating film 8a in this embodiment mode 1 has been designed as follows: That is, for example, a P-polarized light reflectance factor of the wavelength “λ1” is designed to be approximately 50% and an S-polarized light reflectance factor thereof is designed to be approximately 100%; a P-polarized light reflectance factor of the wavelength “λ2” is designed to be approximately 90%, and an S-polarized light reflectance factor of both the wavelength “λ1” and the wavelength “λ2” is designed to be approximately 100%. However, it should be understood that these numeral values may be changed, depending upon constants comprised by optical components which constitute the optical system, and designing constants of the optical system, and optimum film characteristics are different from each other every optical system.

Also, the total reflecting film b is manufactured by either a dielectric multi-layer film or a metal film. As indicated in FIG. 3(a), in such a case that this total reflecting film 8b is manufactured by the dielectric multi-layer film, 20 layers, or less layers of both high refractive index films 8h and low refractive index films 8i have been alternately stacked with each other. As the high refractive index film 8h, there are TiO₂, Nb₂O₅, Ta₂O₅, Al₂O₃, and the like. Also, as the low refractive index film 8i, there are SiO₂, MgF₂, and the like. Thickness of the respective films 8h and 8i are 100 to 200 nm.

As indicated in FIG. 3(b), in the case that the total reflecting film 8b is manufactured by a metal film 8j, this total reflecting film 8b is constituted by a single layer of the metal film 8j. As this metal film 8j, there are Au, Ag, Al, Pt, and the like.

Also, as indicated in FIG. 3(c), a protection film 8k may be formed on a surface of the metal film 8j in order to protect this metal film 8j, while the protection film 8k is made of a dielectric material such as SiO₂. Also, if a necessary optical characteristic as to this protection film 8k can be obtained, as indicated in FIG. 3(c), then the protection film 8k may be formed on the region of the wavelength selective polarized light separating film 8a and the entire region of the total reflecting film 8b as a final one layer of this wavelength selective polarized light separating film 8a. Alternatively, both the wavelength selective polarized light separating film 8a and the total reflecting film 8b may be formed on the entire region all at once, and then, only a portion of the wavelength selective polarized light separating film 8a may be removed which corresponds to the total reflecting film 8b, so that this removed portion may be used as the wavelength selective polarized light separating film 8a. In this alternative case, the total reflecting film 8b is manufactured by such a dielectric layer having the same composition and the same film thickness as those of the wavelength selective polarized light separating film 8a, and the necessary optical characteristic must be obtained.

A region 8c having a predetermined dimension and a pre-selected shape, in which the total reflecting film 8b is not formed, is provided at a place corresponding to center portions of the light projected from the light emitting point 2 and of the light projected from the light emitting point 3. In this embodiment mode 1, this region 8c is selected to be a region located in the vicinity of the optical axis of the optical system. Concretely speaking, as shown in FIG. 4(a), in the case that the P-polarized light reflectance factor as to the wavelength selective polarized light separating film 8a having the wavelength λ1 is approximately 50%, such a region is selected to be the above-described region 8c, which is approximately 65% smaller than the region where the luminous flux is distributed along a direction equivalent to the radial direction of the optical disk 12, and also, a boundary line between the region 8c and the total reflecting film 8b is formed as a straight line shape along a direction equivalent to a tangential line direction of a circumference. In other words, the region 8c is made in a long strip shape. Also, in the case that the P-polarized light reflectance factor as to the wavelength selective polarized light separating film 8a having the wavelength λ1 is approximately 75%, it is preferable that such a region is selected to be the above-described region 8c, which is approximately 45% smaller than the region where the luminous flux is distributed along a direction equivalent to the radial direction of the optical disk 12. Alternatively, the region 8c is not made of the long strip shape, but such a region having an ellipse shape may be used as the region 8c, which is approximately 90 to 95% smaller than the region where the luminous flux is distributed along the direction equivalent to the tangential direction of the circumference of the optical disk 12.

It should be understood that although the shapes as to the plane 7a and the plane 7b of the optical transmission member 7 have been made in the substantially rectangular shapes in this embodiment mode 1, four corners thereof may be alternatively chamfered by C plane, or chamfered by R plane. Since only such a necessary minimum region into/from which luminous flux can be entered/projected is merely required, an ellipse shape and a corner-rounded rectangular shape may be formed as this region 8c, which are fitted to the necessary minimum region.

A raising prism 9 corresponds to such a prism which is used to raise the optical axis which has been so far located within a plane substantially parallel to the plane of the optical disk 12 at a substantially vertical direction with respect to the plane of the optical disk 12, and may be alternatively formed as a mirror. A hologram element 10 has be arranged by a polarization hologram 10a and a ¼ wavelength plate 10b. The hologram element 10 has been manufactured by a material having a wavelength selecting characteristic which may be effected only to the light having the wavelength λ1. Also, as to the ¼ wavelength plate 10b, both a refractive index and a thickness have been set in such a manner that this ¼ wavelength plate 10b may be effected both to the wavelengths λ1 and λ2. The hologram element 10 has been fixed to a common member (not shown) in combination with the objective lens 11, and thus, may be moved together with the objective lens 11.

As to the optical disk 12, there are CD, CD-ROM CD-R/RW in a CD series, whereas there are DVDROM DVD±R/RW, DVD-RAM in a DVD series. All of these optical disks can be recorded as well as reproduced except for reproduction-only media in the CD series and DVD series. Also, not only combinations between the CD series and the DVD series, but also such a combination between a so-called “blue ray laser disk” and an HD-DVD do not lose the general characteristics.

A fore light monitor 13 corresponds to such a sensor which receives a portion of the light emitted from the light emitting point 2 and the light emitting point 3, and converts an amount of the received light into an electric signal, and then, outputs this electric signal. Then, the electric signal is supplied to a control circuit (not shown) which controls a drive circuit (not shown) of the two-wavelength semiconductor laser light source 1 in such a manner that a light amount of a collective spot collected on the optical disk 12 becomes constant. Also, a light receiving sensor 14 receives light reflected from the optical disk 12, and converts this received reflection light into an electric signal, and then outputs this converted electric signal by which an RF signal, a tracking error signal, a focusing error signal, and the like are produced.

Also, as indicated in FIG. 5(a), and FIG. 5(b), or in FIG. 6, the above-explained respective optical components are directly fixed on a carriage 51, or are fixed via other members on this carriage 51 so as to constitute an optical pickup apparatus 50.

Further, concretely speaking, the two-wavelength semiconductor laser light source 1, the diffraction grating 4, the integrated prism 5, and the light receiving sensor 14 are fixed on a coupling base 52 so as to be fixed on the carriage 51. The collimator lens 6, the optical transmission member 7 which is provided with the filter 8, and the raising prism 9 are fixed on the carriage 51 both the hologram element 10 and the objective lens 11 are fixed on a lens holder 54 of an actuator 53 fixed on the carriage 51. The lens holder 54 is supported within the actuator 53 under movable condition.

Next, a description is made of an optical path with reference to FIG. 1. The light emitted from the light emitting point 2 penetrates the diffraction grating 4, and the integrated prism 5, and then, is entered to the collimator lens 6. The entered light is converted by this collimator lens 6 into substantially parallel light which passes through the optical transmission member 7, and is reflected by the filter 8. This reflected light again passes through the optical transmission member 7, and then, is entered to the raising prism 9. Further, the entered light passes through the raising prism 9, the hologram element 10, and the objective lens 11, and then, is focused on the optical disk 12.

Generally speaking, if a ratio of optical intensity at an aperture center portion of the objective lens 11 to optical intensity at an aperture edge portion thereof is large as shown as a curve of FIG. 7(a) in which no filter is employed, then a light collected spot on the optical disk 12 is not narrowed, but becomes such a curve of FIG. 7(b) in which no filter is employed.

The light entered to the filter 8 corresponds to P-polarized light, approximately 50% of light 15b entered to the region 8c where the total reflecting film 8b is not formed is reflected, so that this reflected light becomes such a light 16b which is directed to the optical disk 12. The remaining 50% light 15b passes through the wavelength selective polarized light separating film 8a, and then, becomes such a light 17 which will be entered to the fore light monitor 13. All of light amounts of light 15a which is entered to a region other than the region 8c are reflected due to the total reflecting film 8b, and this reflected light 15a constitutes such a light 16a which is directed to the optical disk 12. As a result, as shown in FIG. 7(a), since the light 16a is reflected by the filter 8, the optical intensity distribution at the aperture plane of the objective lens 11 is converted into such an intensity distribution that a center portion is lowered from a broken line to a solid line. When this light is collected on the optical disk 12 to be focused thereon, as indicated in FIG. 7(b), the optical intensity distribution indicated by the broken line is converted into such an optical intensity distribution of such an optical collective spot as shown by the solid line, which is concentrated to a narrower region. In other words the optical collective spot is made narrower. This phenomenon is referred to as a “super-resolution phenomenon.” Since the optical intensity distribution at the aperture plane of the objective lens 11 is optimized in order to be fitted to the optical system, the optical collective spot may be made narrower, and also, a raised portion of the peripheral portion (called as “side lobe”) may be suppressed to a low portion.

Also, the filter 8 may function as a beam splitter which reflects the light emitted from the light emitting point 2 so as to separate this reflected light into light which is entered to the optical disk 12, and another light which passes through the beams splitter to be entered to the fore light monitor 13. As previously explained, the light emitted from the light emitting point 2 may be effectively used, since such a light which is not directed to the optical disk 12 is employed in the light amount control operation.

Also, in this embodiment mode 1, a deterioration of the aberration can be prevented by employing such a structure that the light entered to the filter 8 penetrates the optical transmission member 7, and is then reflected from the wavelength selective polarized light separating film 8a formed on the flat plane 7a. Assuming now that the filter 8 is arranged in such a manner that the light entered to the filter 8 is entered not via the optical transmission member 7 to this wavelength selective polarized light separating film 8a, such a structure is made that the total reflecting film 8b is formed on the surface of the optical transmission member 7, and the wavelength selective polarized light separating film 8a is formed on this surface. If such an assumed structure is employed, then a stepped portion caused by the total reflecting film 8b is produced on the surface of this wavelength selective polarized light separating film 8a, so that the light reflected from this stepped portion may cause the adverse effect of aberration, by which the quality of the optical collective spot may be deteriorated, and further, may not be narrowed. It should also be understood that in this embodiment mode 1, the optical arrangement can provide that the deterioration of the aberration does not occur from the beginning. However, if an adverse influence is small, then such an optical structure may be alternatively employed in which the light entered to the filter 8 is not transmitted via the optical transmission member 7.

Also, the polarizing direction of the light has been set in such a manner that when the light passes through the hologram element 10, this light may pass therethrough without receiving the influence of the polarizing hologram 10a, and this light is converted by the ¼ wavelength plate 10b from the linearly polarized light to the circularly polarized light.

Light which is reflected from the optical disk 12 passes through the objective lens 11, the hologram element 10, the raising prism 9, the optical transmission member 7, the filter 8, and the collimator lens 6, and thereafter, is entered to the integrated prism 5. When the light again passes through the hologram element 10, this light is converted by the ¼ wavelength plate 10b from the circularly polarized light into such a linearly polarized light which is positioned perpendicular to the linearly polarized light of the incoming optical path, namely S-polarized light. This S-polarized light is separated by the polarizing hologram 10a into signal light components which correspond to the RF signal, the tracking error signal, the focusing error signal, and the like. Since the filter 8 has been designed by that all of the S-polarized light is reflected from this filter 8, there is no change in the optical intensity distribution.

A polarized light separating film provided on the inclined plane 5a within the integrated prism 5 has employed such a polarized light separating film structure that such P-polarized light which is emitted from the light emitting point 2 and the light emitting point 3 passes through this separating film, whereas such an S-polarized light is reflected from this separating film, which has emitted from the light emitting point 2 and then been reflected from the optical disk 12. As a consequence, the light entered to the integrated prism 5 is reflected by the polarized light separating film provided on the inclined plane 5a, and is then entered to the light receiving sensor 14. The respective signal light components which are separated by the polarizing hologram 10a and is then entered to the light receiving sensor 14 are converted into various sorts of electric signals by this right receiving sensor 14.

The light emitted from the light emitting point 3 passes through the diffractive grating 4 and the integrated prism 5, and is then entered to the collimator lens 6. This entered light is converted into substantially parallel light by this collimator lens 6, and then, this parallel light passes through the optical transmission member 7 to be reflected from the filter 8. The reflected light again passes through the optical transmission member 7 and is then entered to the raising prism 9. Furthermore, this entered light passes through the raising prism 9, the hologram element 10, and the objective lens 11, and then, is focused on the optical disk 12.

At this time, while the light entered to the filter 8 corresponds to P-polarized light, 92% to 93% of the light 15b entered to the region where the total reflecting film 8b is not formed is reflected, and the reflected light becomes such a light 16b which is directed to the optical disk 12. The remaining 7% to 8% of this light passes through the wavelength selective polarized light separating film 8a, and then, becomes such a light 17 which is entered to the fore light monitor 13. All amounts of the light 15a entered to the region other than the region 8c are reflected due to the total reflecting film 8b, and this reflected light constitutes such a light 16a which is directed to the optical disk 12. As a consequence, an optical intensity distribution of the light directed to the optical disk 12 is different from that of the case for the light emitting point 2, and is approximated to such a distribution obtained without the filter of FIG. 7(a), since a difference between the reflectance factor of the aperture center portion of the objective lens 11, and the reflectance factor of the aperture edge portion thereof is small. As a result, an optical intensity distribution of an optical collective spot in this place is also approximated to such a distribution obtained without the filter of FIG. 7(b).

Also, in this time, the filter 8 may function as a beam splitter which reflects the light emitted from the light emitting point 3 so as to separate this reflected light into light which is entered to the optical disk 12, and another light which passes through the beams splitter to be entered to the fore light monitor 13. As previously explained, the light emitted from the light emitting point 3 may also be effectively used, since such a light which is not directed to the optical disk 12 is employed in the light amount control operation. Since the optical magnification is lowered, the utilization efficiency as to the light emitted from the light emitting point 3 may be further increased, and therefore, this light may be furthermore suitable for recording operations in high double speeds.

Also, when the light passes through the hologram element 10, since no adverse influence of the polarizing hologram 10a is not received in this wavelength λ2, this light directly passes through this hologram element 10, and then, is converted by the ¼ wavelength plate 10b from the linearly polarized light into circularly polarized light.

Light which is reflected from the optical disk 12 passes through the objective lens 11, the hologram element 10, the raising prism 9, the optical transmission member 7, the filter 8, and the collimator lens 6, and thereafter, is entered to the integrated prism 5. When the light again passes through the hologram element 10, this light is converted by the ¼ wavelength plate 10b from the circularly polarized light into such a linearly polarized light which is positioned perpendicular to the linearly polarized light of the incoming optical path, namely S-polarized light. Then, since the influence of the polarizing hologram 10a is not received in this wavelength λ2, this S-polarized light directly passes through the polarizing hologram 10a. Since the filter 8 has been designed by that all of the S-polarized light is reflected from this filter 8, there is no change in the optical intensity distribution.

A polarized light separating film provided on the inclined plane 5b within the integrated prism 5 has employed such a polarized light separating film structure that such a light which is emitted from the light emitting point 2 and the light emitting point 3 passes through this separating film, whereas such a light is reflected from this separating film, which has emitted from the light emitting point 2 and then been reflected from the optical disk 12. As a consequence, the light entered to the integrated prism 5 is reflected by the polarized light separating film provided on the inclined plane 5b, and is then separated by the hologram element provided on the inclined plane 5c, and thus, the separated light is entered to the light receiving sensor 14 so as to be converted into various sorts of electric signals.

It should be understood that in this embodiment mode 1, the filter 8 has been formed on the optical transmission member 7 as the beam splitter. However, the present invention is not limited only to this structure, but may be applied to the following structure. That is, for example, while the filter 8 may be formed on a plane 9a which is not located opposite to the light emitting point 2 and the light emitting point 3 of the raising prism 9, and the optical disk 12, the filter 8 of the optical transmission member 7 may be eliminated, and the polarized light separating film may be provided on the plane 7b.

As previously explained, in the embodiment mode 1 of the present invention, since the respective light having the different wavelengths emitted from the respective light emitting points is converted into the predetermined optical intensity distributions, the optical intensity distributions of the optical spots collected on the optical disk 12 can be optimized with respect to the respective wavelengths. As a result, since the light emitted from a certain light emitting point is converted into the predetermined optical intensity distribution, a so-called “super-resolution phenomenon” may be occur. Therefore, the diameter of the main optical collective spot can be made smaller than the diameter in such a case that the emitted light is not converted to the predetermined optical intensity distribution, and a so-called “side lobe” corresponding to the raised portion of the peripheral optical intensity distribution can be suppressed to the small side lobe. As a result, the aberration of the optical collective spots on the optical disk 12 can be suppressed to the low aberration value. On the other hand, since such an optical intensity distribution conversion is not carried out with respect to such a light emitting point which does not require this optical intensity distribution conversion, the optical utilization efficiency is not lowered. As previously explained, the optimum collective light spots can be realized with respect to the light emitted from the respective light emitting points, while an independent optical component is not newly and additionally employed. As a consequence, while the feature of the low cost is maintained, such an optical pickup apparatus can be realized with employment of the light source in which the plural light emitting points having the different wavelengths are provided in proximity to each other, by which the light emitted from the light emitting point with any wavelength can be used both in the recording operation and the reproducing operation in the high double speeds.

### Embodiment Mode 2

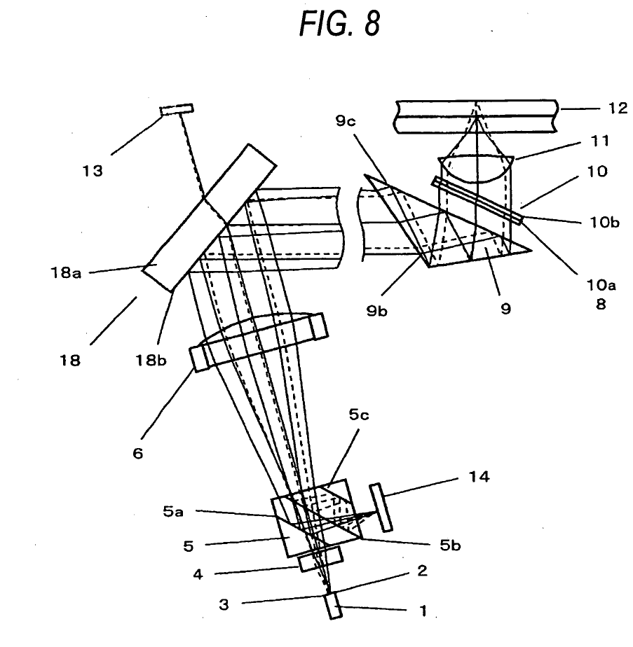

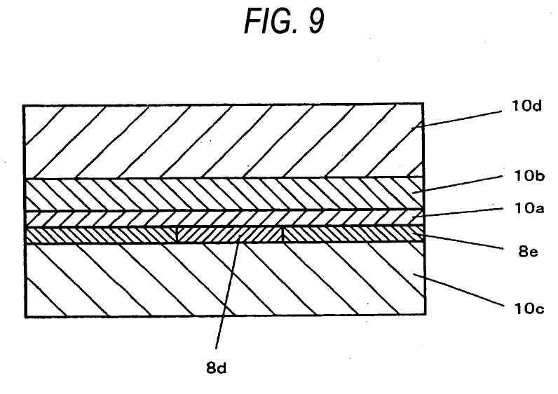

An optical pickup apparatus according to an embodiment mode 2 of the present invention will now be described with reference to drawings. FIG. 8 is a schematic diagram for showing an optical system of the optical pickup apparatus according to the embodiment mode 2 of the present invention. FIG. 9 is an enlarged view for showing a filter unit of this embodiment mode 2. In the embodiment mode 2, a filter 8 comprises such a structure that this filter 8 penetrates therethrough light emitted from a light emitting point 2 and light emitted from another light emitting point 3, and then, enters the penetrated light to the optical disk 12.

A first description is made of a structure of this optical pickup apparatus with reference to FIG. 8. In the above-explained embodiment mode 1, the filter 8 has been formed on the optical transmission member 7, whereas in this embodiment mode 2, the filter 8 has been formed on a hologram element 10, and a beam splitter 18 has been installed instead of both the optical transmission member 7 and the filter 8. Since other structural elements are identical to those of the embodiment mode 1, explanations thereof are utilized.

As indicated in FIG. 9, the hologram element 10 comprises such a structure that between a substrate 10c on the side of the two-wavelength semiconductor laser light source 1 manufactured by optical glass and another substrate 10d on the side of the optical disk 12, a polarizing hologram 10a is provided on the side of the two-wavelength semiconductor laser light source 1, and a ¼ wavelength plate 10b is provided on the side of the optical disk 12. In this embodiment mode 2, the hologram element 10 is arranged by employing such a filter 8 which is equipped with a wavelength selective polarized light transmitting film 8d and a total transmitting film 8e between the polarizing hologram 10a and the substrate 10c. Similar to the embodiment mode 1, the hologram element 10 equipped with the filter 8 has been fixed on a common member (not shown) in combination with the objective lens 11, and is moved together with the objective lens 11. It should be understood that the filter 8 may be positioned close to the two-wavelength semiconductor laser light source 1 rather than the ¼ wavelength plate 10b, and therefore, may be alternatively manufactured on a plane of the substrate 10c on the light source side, or manufactured on a plane of the polarizing hologram 10a on the side of the laser disk 12.

The wavelength selective polarized light transmitting film 8d is manufactured by a dielectric multi-layer film, while the optical axis of the optical system is set to a center. In the dielectric multi-layer film 50 layers, or less layers of both high refractive index films and low refractive index films are alternately stacked with each other. As the high refractive index film, there are TiO₂, Nb₂O₅, Ta₂O₅, Al₂O₃, and the like. Also, as the low refractive index film, there are SiO₂, MgF₂, and the like. Thickness of the respective films is 400 to 120 nm. The film characteristics of the wavelength selective polarized light transmitting film 8d have been designed as follows: That is, for example, a P-polarized light transmittance of the wavelength “λ1” is approximately 50%; an S-polarized light transmittance thereof is substantially equal to 100%; and also, both a P-polarized light transmittance and an S-polarized light transmittance of the wavelength “λ2” are substantially equal to 100%. However, it should be understood that these numeral values may be changed, depending upon constants comprised by optical components which constitute the optical system, and designing constants of the optical system, and optimum film characteristics are different from each other every optical system. The total transmitting film 8e is manufactured by a dielectric multi-layer film. In the dielectric multi-layer film, 10 layers, or less layers of both high refractive index films and low refractive index films are alternately stacked with each other. As the high refractive index film, there are TiO₂, Nb₂O₅, Ta₂O₅, Al₂O₃, and the like. Also, as the low refractive index film, there are SiO₂, MgF₂, and the like. Thickness of the respective films is 30 to 100 nm. In order to solve a stepped portion which is caused by the wavelength selective polarized light transmitting film 8d, the total transmitting film 8e is continuously formed on the same plane as the wavelength selective polarized light transmitting film 8d outside this wavelength selective polarized light transmitting film 8d.

Also, the beam splitter 18 has been constituted by that a polarized light separating film 18b has been formed on a surface of a substrate 18a manufactured by either optical glass or optical plastic on the side of the two-wavelength semiconductor laser light source 1. The polarized light separating film 18b is manufactured by a dielectric multi-layer film. The polarized light separating film 18b has been designed in such a way that this polarized light separating film 18b penetrates therethrough a portion of the light emitted from the light emitting point 2 and the light emitting point 3, reflects thereon a major portion of the remaining light to direct the reflected light toward the optical disk 12, and light reflected from the optical disk 12 is totally reflected to be directed toward the light receiving sensor 14.

Next, an optical path will now be explained. Similar to the embodiment mode 1, the light emitted from the light emitting point 2 and the light emitting point 3 is converted into substantially parallel light by the collimator lens 6, and then, this parallel light is entered to the beam splitter 18. The light which passes through the beam splitter 18 is entered to the fore light monitor 13. The light which is reflected by the beam splitter 18 is raised by the raising prism 9 to the direction of the optical disk 12, and then, this raised light is entered to the hologram element 10 equipped with the filter 8. At this time, since the light emitted from the light emitting point 2 corresponds to P-polarized light, approximately 50% of this P-polarized light may pass through the wavelength selective polarized light transmitting film 8d; an optical intensity distribution at the aperture plane of the objective lens 11 becomes such a distribution with a filter shown in FIG. 7(a); and an optical intensity distribution on the optical disk 12 becomes such a distribution with a filter shown in FIG. 7(b). On the other hand, since the light emitted from the light emitting point 3 also corresponds to P-polarized light, approximately 100% of this P-polarized light may pass through the wavelength selective polarized light transmitting film 8d; an optical intensity distribution at the aperture plane of the objective lens 11 becomes such a distribution with a filter shown in FIG. 7(a); and an optical intensity distribution on the optical disk 12 becomes such a distribution with a filter shown in FIG. 7(b). The light which has passed through the filter 8 and the polarizing hologram 12 is converted by the ¼ wavelength plate 10b from the P-polarized light to the circularly polarized light, and then, this circularly polarized light is collected by the objective lens 11 onto the optical disk 12.

Since the light reflected from the optical disk 12 again passes through the ¼ wavelength plate 10b formed in the hologram element 10, this reflected light is converted from the circularly polarized light to the S-polarized light, and then, the S-polarized light is entered to the filter 8. Since the light emitted from the light emitting point 2 as well as the light emitted from the light emitting point 3 correspond to the S-polarized light, substantially 100% of this S-polarized light penetrates the filter 8, and substantially 100% of this penetrated S-polarized light is reflected by the beam splitter 18, and then, the reflected S-polarized light is traveled via the collimator lens 6 to the light receiving sensor 14.

It should be understood that the filter 8 is not provided on the hologram element 10, but may be alternatively provided on such a plane of the diffraction grating 4, which is located opposite to the plane where the diffraction grating 4 is actually provided; a plane 9b of the raising prism 9, which is located opposite to the two wavelength semiconductor laser light source 1; or a plane 9c of the raising prism 9, which is located opposite to the optical disk 12. As previously explained, when the filter 8 is used in the light transmission, a freedom degree of a design thereof is high. When the filter 8 is provided on the plane of the diffraction grating 4, which is located opposite to the plane where the diffraction grating 4 is actually provided, the light reflected from the optical disk 12 does not pass through this filter 8, but is entered to the light receiving sensor 14. As a result, the wavelength selective polarized light transmitting film 8d may be preferably provided as such a wavelength selective transmitting film by which, for example, approximately 50% of the light emitted from the light emitting point 2 may be penetrated, and approximately 100% of the light emitted from the light emitting point 3 may be penetrated. Also, this wavelength selective polarized light transmitting film 8d may be preferably provided as such a film that the total transmitting film 8e may penetrate substantially 100% of the light emitted from the light emitting point 2 and the light emitting point 3.

As previously described, since the optical pickup apparatus of the embodiment mode 2 is arranged in the above-described manner, a similar effect to that of the embodiment mode 1 can be achieved. Furthermore, in such a case that the filter 8 is provided on the hologram element 10, since the filter 8 is moved in combination with the objective lens 11, the recording/reproducing characteristic can be further improved.

### Embodiment Mode 3

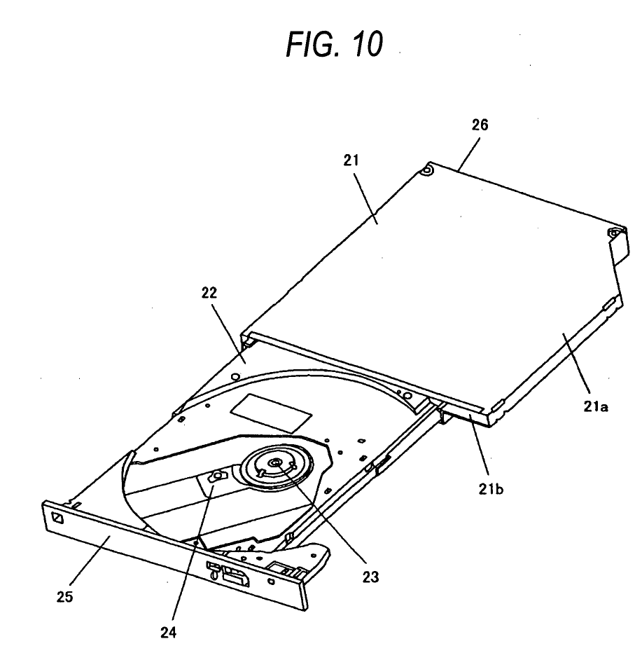

FIG. 10 is a perspective view for indicating an optical disk apparatus according to an embodiment mode 3 of the present invention. In FIG. 10, a housing 21 has been constructed by combining an upper housing 21a with a lower housing 21b. A tray 22 has been slidably provided with the housing 21. A spindle motor 23 and an optical pickup apparatus 24 have been provided on a tray 22, while this spindle motor 23 corresponds to a rotation driving means for rotating the optical disk 12. While the optical pickup apparatus 24 is equipped with the optical system having the filter 8 indicated in either the embodiment mode 1 or the embodiment mode 2, the optical pickup apparatus 24 performs at least one of an operation for writing information in the optical disk 12, and another operation for reading information from the optical disk 12.

At this time, an optical intensity distribution on the optical disk 12 is indicated in FIG. 7(b). Also, a feed driving system (not shown) has been provided within the tray 22, and corresponds to a moving means for approaching and/or removing the optical pickup apparatus 24 within the spindle motor 23. A bezel 25 has been provided at a front edge plane of the tray 22, and has been arranged in such a manner that when the tray 22 is stored in the housing 21, this bezel 25 closes an entrance/exist port of the tray 22. A circuit board (not shown) has been provided inside the housing 21, or inside the tray 22, and an IC of a signal processing system, a power supply circuit, and the like have been mounted on this circuit board. An external connector 26 (not shown) is connected to a power supply/signal line which is provided in an electronic appliance such as a computer. Then, electric power is supplied via the external connector 26 to the optical disk apparatus, or an electric signal derived from an external unit is conducted to the optical disk apparatus, or an electric signal produced from the optical disk apparatus is sent to an electronic appliance, and the like. The optical disk apparatus which mounts thereon the above-explained pickup apparatus 24 equipped with the optical system having the filter 8, which is indicated in the embodiment mode 1, or the embodiment mode 2, can perform the recording operation and the reproducing operation with respect also to the optical disk 12 used in any wavelengths in the higher double speeds.

### Embodiment Mode 4

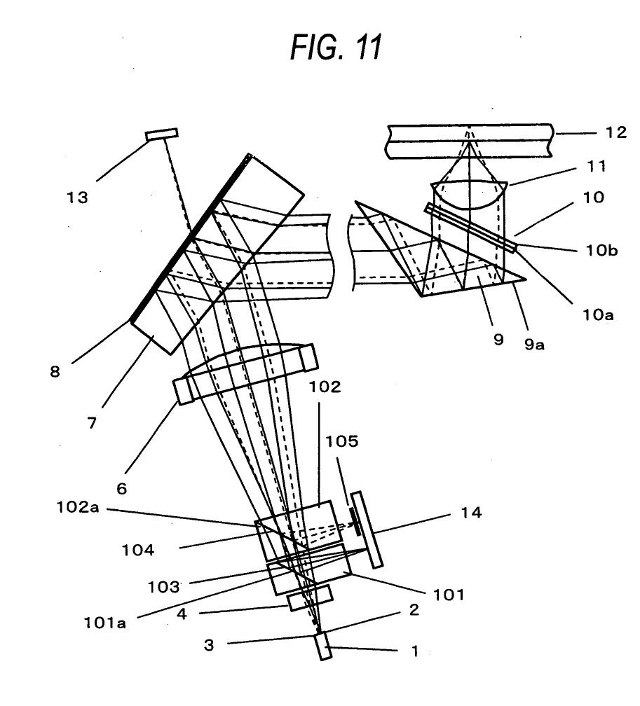

FIG. 11 is a schematic diagram for showing an optical system of an optical pickup according to an embodiment mode 4 of the present invention. In the optical pickup of this embodiment mode 4, while the integrated prism 5 of the embodiment mode 1 is not used, prisms 101 and 102, and a hologram 105 have been arranged. The prism 101 is arranged at the diffraction grating 4 on the side of the optical disk 12, and the prism 102 is arranged at the prism 101 on the side of the optical disk 12. Both the prisms 101 and 102 are fixed on a coupling base 52. Also, the hologram 105 is arranged on the surface side of the light receiving sensor 14. Other structural elements of this embodiment mode 4 are the same as those of the embodiment mode 1, so that explanations thereof will be utilized. Both the prism 101 and the prism 102 are made in the form of a substantially rectangular sold as an entire form by joining blocks to each other by employing glass and an ultraviolet ray hardening adhesive agent, while these blocks are made of either transparent optical glass or an optical resin. The prisms 101 and 102 comprise inclined planes 101a and 102a within these prisms as joining planes of the respective blocks. A polarized light separating film 103 is formed on the inclined plane 101a. A wavelength selective polarized light separating film 104 is formed on the inclined plane 102. The polarized light separating film 103 penetrates therethrough substantially P-polarized light and reflects therefrom substantially S-polarized light as to the laser light having the wavelength λ1 for the DVD purpose. The polarized light separating film 103 penetrates therethrough substantially P-polarized light and also substantially S-polarized light as to the laser light having the wavelength λ2 for the CD purpose. The wavelength selective polarized light separating film 104 penetrates therethrough substantially P-polarized light and also substantially S-polarized light as to the laser light having the wavelength λ1 for the DVD purpose. The wavelength selective polarized light separating film 104 penetrates therethrough substantially P-polarized light and reflects therefrom substantially S-polarized light as to the laser light having the wavelength λ2 for the CD purpose. As a consequence, the laser light emitted from the light emitting points 2 and 3 of the two-wavelength semiconductor laser light source 1 penetrate through the prism 101 and the prism 102, and then, are directed to the optical disk 12. On the other hand, among the laser light reflected from the optical disk 12, the laser light having the wavelength λ2 is reflected from the wavelength selective polarized light separating film 104, and then, the reflected laser light is directed to the light receiving sensor 14. The laser light having the wavelength λ1 reflected from the optical disk 12 penetrates through the wavelength selective polarized light separating film 104, and then, is reflected by the polarized light separating film 103, and this reflected laser light is directed to the light receiving sensor 14.

The hologram 105 has been provided on the light receiving sensor 14 on the side of the prism 102 on the optical path of the laser light having the wavelength λ2. The hologram 105 separates the laser light having the wavelength λ2 into signal light components corresponding to an RF signal, a tracking error signal, a focusing error signal, and the like, and then enters these separated signal light components to the light receiving sensor 14.

It should be noted that although the hologram 105 has been provided on the side of the light receiving sensor 14 in the embodiment mode 4, this hologram 104 may be alternatively provided on the plane of the prism 102, which is located opposite to the light receiving sensor 14.

As previously explained, in this embodiment mode 4, the optical system can be arranged without employing the integrated prism 5. In this case, since the prisms which have been integrated become a single component of prism, an entire dimension becomes slightly large. However, since such an integrated prism 5 which should be manufactured in high precision is no longer required, the manufacturing cost can be suppressed.

### Embodiment Mode 5

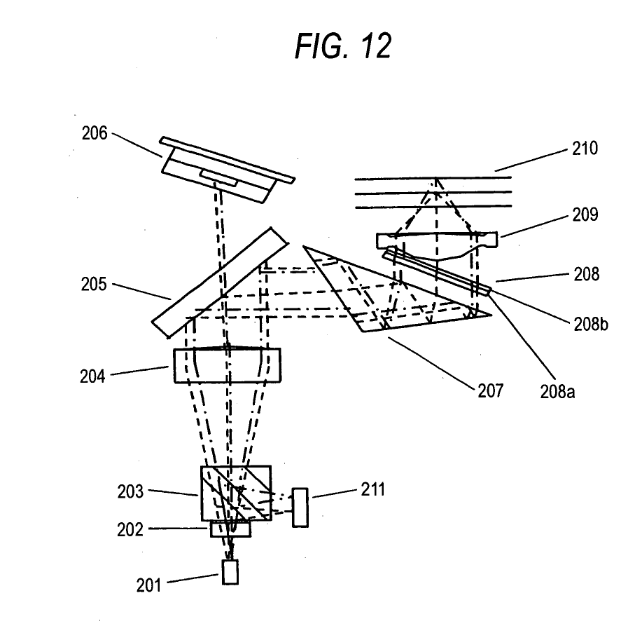

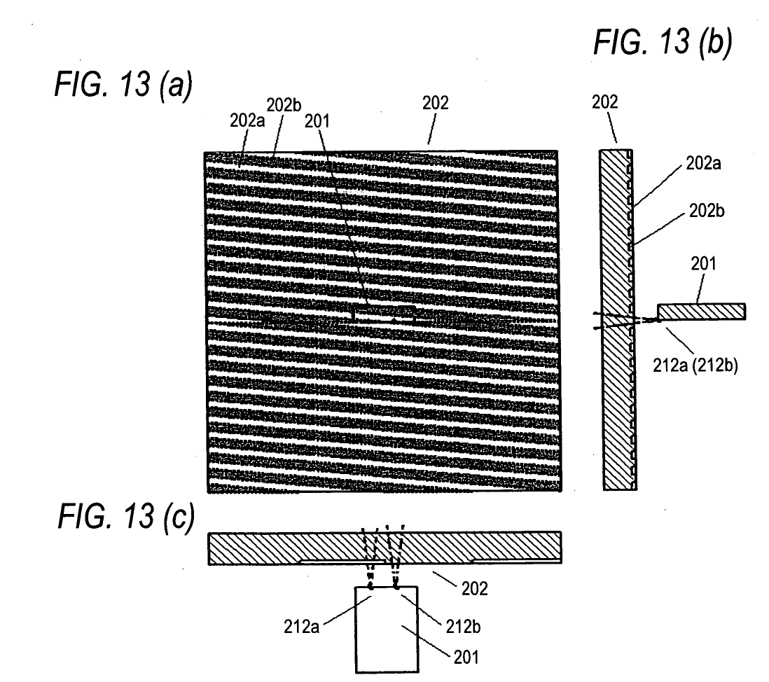

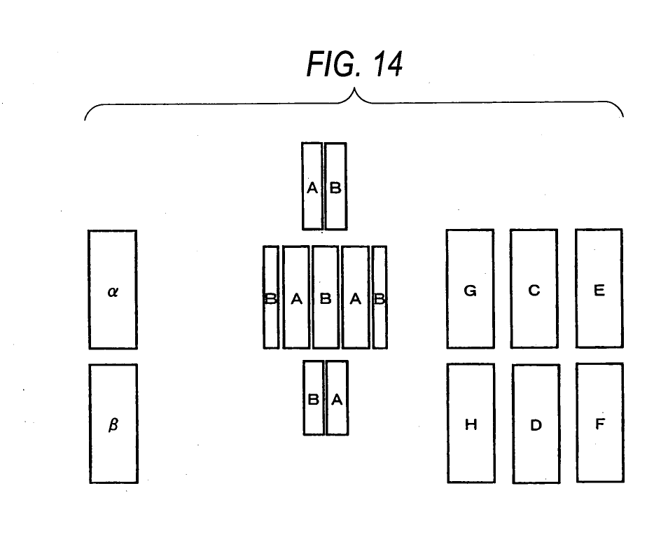

FIG. 12 is a schematic diagram for showing an entire optical system of the optical pickup apparatus using a two-wavelength semiconductor laser according to the embodiment mode 5 of the present invention. FIG. 13(a) to FIG. 13(c) are an upper view, a side view, and a front view for showing an enlarged two-wavelength semiconductor laser and a diffraction grating of this embodiment mode 5. FIG. 14 shows an example of an arranging diagram as to a light receiving portion of a light receiving sensor in the embodiment mode 5. Referring now to FIG. 12 to FIG. 14, a description is made of the optical system of the optical pickup apparatus with employment of the two-wavelength semiconductor laser according to the embodiment mode 5 of the present invention.

Firstly, an arrangement will now be described. A two-wavelength semiconductor laser 201 corresponding to such a light source that a plurality of light emitting points are provided in proximity to each other comprises a light emitting point 212a for a DVD purpose and another light emitting point 212b for a CD purpose separated over a distance of approximately 110 am. In FIG. 12 and FIG. 13, the two-wavelength semiconductor laser 201 corresponds to such a semiconductor laser element that light sources having a plurality of wavelengths have been integrated on a single semiconductor substrate (so-called “monolithic type two-wavelength semiconductor laser”). Alternatively, such a semiconductor laser element that laser elements having a plurality of different wavelengths have been arranged adjacent to each other within a single package (so-called “hybrid type two-wavelength semiconductor laser”) may be employed.

While a diffraction grating 202 is manufactured by an optical glass and the like, as indicated in FIG. 13, grooves have been formed in a surface of the plane on the side of the two-wavelength semiconductor laser 201 in a pitch of approximately 15 μm and a depth of approximately 200 nm. This plane is located perpendicular to an optical axis of laser light emitted from the light emitting points 212a and 212b. Widths of hills of these grooves are nearly equal to widths of valleys thereof. The laser light entered to the diffraction grating 202 is separated into one main beam and two side beams located on both sides of this main beam by the grooves. The direction of the grooves is determined in such a manner that the three beams are arrayed on an optical disk 210 at a very small angle with respect to the tangential direction of the circumference. In this embodiment mode 5, the grooves are subdivided into two regions in which a phase of a hill becomes substantially opposite to a phase of valley in the vicinity of the light emitting points 212a and 212b, and a boundary between these two regions is directed which penetrates therethrough a center of the rays emitted from the two-wavelength semiconductor laser 1 and corresponds to the tangential direction of the circumference of the optical disk 210. Also, when the diffraction grating 202 is manufactured, since the mask pattern of the groove shape is merely changed from the conventional groove shape into the groove shape of this embodiment mode 5, the resulting manufacturing cost is not largely different from the conventional manufacturing cost.

An integrated optical member 203 has been manufactured by such an optical glass that a plurality of inclined planes have been provided inside this optical member 203, while polarized light separating films and the like have been formed on the inclined planes. A collimator lens 204 corresponds to such a lens which collimates laser light into substantially parallel light in incoming light, and has been manufactured by either optical glass or optical plastics. A BS plate 205 has been manufactured by optical glass, and the like, a BS film has been manufactured on a surface of this BS plate 205, and this BS plate 205 passes through only a portion of the laser light, and reflects a major portion of this laser light. A fore light monitor 206 corresponds to an optical sensor and monitors a light amount of a portion of the laser light emitted from the two-wavelength semiconductor laser 201. Since this monitored light amount is fed back via a control circuit (not shown) to the two-wavelength semiconductor laser 201, this fore light monitor 206 may be operated in such a way that the light amounts of the laser light form the two-wavelength semiconductor laser 201 are kept constant. A raising prism 207 raises the optical axis which has been located within a plane which is located substantially parallel to the plane of the optical disk 210 along a substantially vertical line with respect to the optical disk 210. Although the raising prism 207 is employed in this embodiment mode 5, a raising mirror may be alternatively employed. A hologram element 208 has been constituted by a polarizing hologram 208a and a ¼ wavelength plate 208b. The polarizing hologram 208 has been manufactured by such a material having a wavelength selective characteristic in such a manner that this polarizing hologram 208a may give an effect only to light having a wavelength for a DVD purpose. Also, as to the ¼ wavelength plate 208b, a refractive index and a thickness have been set in order that this ¼ wavelength plate 208b may give an effect to both wavelengths for DVD and CD purposes. While an objective lens 209 corresponds to a two-focal-point objective lens, this objective lens 209 has been constituted in such a manner that this object lens 209 focuses the light having the wavelengths for DVD and CD purpose onto two focal points respectively. As this objective lens 209, while a light collective lens is combined with either a Fresnel lens or a hologram lens, an aperture limiting means is provided with a DVD-purpose light collective lens when a CD is reproduced, and such a lens may be employed which absorbs differences in the thickness and the aperture numbers of the optical disks 210. The optical disk 210 comprises both a CD-purpose recording plane and a DVD-purpose recording plane.

A light receiving sensor 211 corresponds to such a light receiving means for receiving reflection light from the optical disk 210 so as to produce an electric signal. This light receiving sensor 211 receives the light reflected from the optical disk 210 so as to produce such electric signals as an RF signal, a tracking error signal, a focusing error signal, and the like. As indicated in FIG. 14, the light receiving sensor 211 is subdivided into several light receiving portions A to H, λ, and β. The above-described various sorts of signals are produced in response to light amounts of light entered to the respective light receiving portions A to H, λ, and β. The RF signal is equal to A+B+C+D+α+β. The tracking error signal for DVD-RAM corresponds to PP=(α+C)−(β+D); the tracking error signal for DVD-ROM corresponds to DPP=<(C−β)+<(α−D), note that symbol “<” indicates a phase difference; and the tracking error signal for CD corresponds to DPP=(α+C)−(D+β)−K·((E+G)−(F+H)). The focusing error signal corresponds to A-B. In this case, the reason why the tracing error signal for CD is different from the tracking error signal for DVD is given as follows: That is, in CD, such a three-beam method that all of a main beam and side beams separated by the diffraction grating 202 are used is employed, whereas in DVD, such a one-beam method that only the main beam is used is employed.

Next, a description is made of an optical path. The laser light emitted from the two-wavelength semiconductor laser 201 is separated into one main laser beam and two side laser beams located on the both sides by the diffraction grating 202. The laser light passes through the integrated optical member 203, and is converted into parallel light by the collimator lens 204. Further, a portion of this parallel light is separated therefrom by the BS plate 205, and is entered to the fore light monitor 206 so as to be used for controlling a light amount of laser light. A direction of the laser light reflected by the BS plate 205 is changed by the raising prism 207 in such a manner that this laser light is vertically entered to the optical disk 210. Next, the polarized light direction of the light has been set in such a manner that the light may directly penetrate the hologram element 208 without receiving the influence of the polarizing hologram 208a, and the light is converted from the linearly polarized light into the circularly polarized light by the ¼ wavelength plate 208b. Then, this circularly polarized light is collected by the objective lens 209 so as to be focused on the optical disk 210.

The laser light reflected from the optical disk 210 is returned to parallel light by the objective lens 209. When this parallel light again passes through the hologram element 208, this light is converted from the circularly polarized light into linearly polarized light whose phase is shifted by 90 degrees with respect to the incoming light by the ¼ wavelength plate 208b. Next, this linearly polarized light is separated into such signal light components corresponding to the RF signal, the tracking error signal, and the focusing error signal by the polarizing hologram 208a. Thereafter, the laser light is traveled through the raising prism 207, the BS plate 205, and the collimator lens 204, and then, is entered to the integrated optical member 203. Since the direction of this polarized light is different from that of the incoming path light, this laser light is separated from the optical path of the incoming path light by the polarized light separating film formed on the inclined plane within the integrated optical member 203, and is traveled through the different optical path to be entered to the light receiving sensor 211.

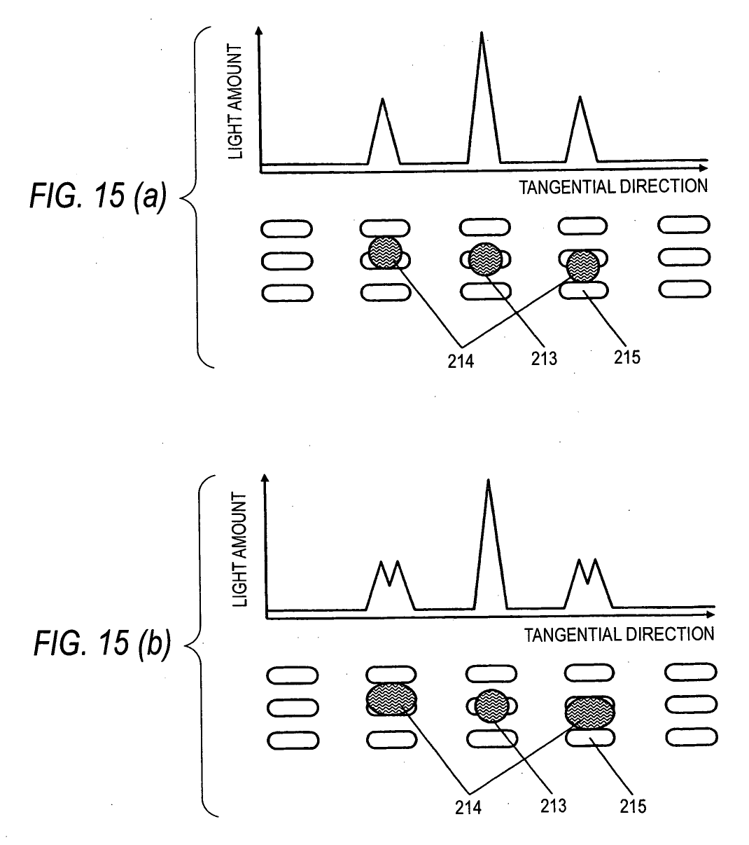

Next, effects will now be explained with reference to FIG. 15. FIG. 15(a) is a schematic diagram for indicating the light amount distribution on the optical disk in the optical pickup apparatus having the conventional arrangement. FIG. 15(b) is a schematic diagram for indicating a light amount distribution on an optical disk in the optical pickup apparatus having the arrangement of the embodiment mode 5. While a main beam 213 having a large light amount is located at a center, side beams 214 having relatively small light amounts are arranged on both sides of the main beam 213 at a very small angle with respect to information pits 215 arranged along the tangential direction of the circumference. The reason why the side beams 214 are shifted from the main beam 213 at the very small angle is to produce a tracking error signal. In the conventional structure, the shape of the side beam 214 is nearly equal to the circle. On the other hand, the side beam 214 in the embodiment mode 5 comprises such a shape that two peaks appear along the tangential direction of the circumference respectively, heights of these peaks are lowered, and are widened along the tangential direction of the circumference. It should be understood that since the depths and the pitches of the grooves formed in the diffraction grating 202 are the same, the entire light amount of the side beams 214 in the conventional structure is equal to that of the side beams 214 in the embodiment mode 5. Also, as to the main beam 213, there is no change in the light amounts and the light amount distributions of both the conventional structure and the embodiment mode 5.

In case of DVD, although the light amounts of the side beams 214 are not changed, the light amount distribution along the tangential direction of the circumference, namely, the direction along which the information pits are arranged is widened. Also, there is no change in the light amount and the light amount distribution as to the main beam 213. As a consequence, since a signal component of another track is reduced by such a side beam 214 which is leaked to the RF signal, an occurrence of jitter components caused by this reduction of the signal component can be suppressed.

Also, in the case of CD, the smaller the light amount distribution of the side beam 214 along the radial direction is decreased, the better the tracking error signal becomes. In the structure of the embodiment mode 5, the light amount distribution along the radial direction is not made wider than that of the conventional structure, and the total light amount thereof is not changed from that of the conventional structure. As a consequence, in this embodiment mode 5, such a better tracking error signal can be obtained which is not changed from that of the conventional structure.

Conversely speaking, both the main beam 213 having the shape and the light amount which are not changed from those of the conventional structure, and the side beams 214 having the long shape only along the tangential direction of the circumference and the entire light amount which is not different from the conventional structure are employed, so that the jitter components of the DVD can be improved, and thus, the optical pickup apparatus which does not give the adverse influence also to the characteristic for CD can be realized. As a consequence, if the above-explained three beam shapes can be realized even when the shape of the refraction grating in this embodiment mode 5 is not employed, then a similar effect may be obtained.

In the embodiment mode 5, the two-wavelength semiconductor laser 201 for both DVD and CD purposes has been explained as the light source in which a plurality of light emitting points are formed. Alternatively, this embodiment mode 5 may be applied to a next-generation light source called as a “blue ray” light source.

It should also be noted that in the embodiment mode 5, as to the phase shift of the grooves formed in the diffraction grating 202, the phase of the hill is substantially reversed to the phase of the valley. The present invention is not limited only to this phase shift relationship. For example, phases of hills and valleys in the grooves may be selected from an in-phase to a reverse phase. The characteristic becomes such a characteristic between the conventional structure (namely, in-phase) and the embodiment mode 5 (namely, reverse phase). As a consequence, if such an effect is expected which may widen the light amount distribution of the side beams 214 along the tangential direction of the circumference, then it is preferable to approximate the phase to the reverse phase.

Also, although the grooves of the diffraction grating 202 are formed on the side of the two-wavelength semiconductor laser 201 in this embodiment mode 5, these grooves may be formed on the side of the optical disk 210.

### Embodiment Mode 6

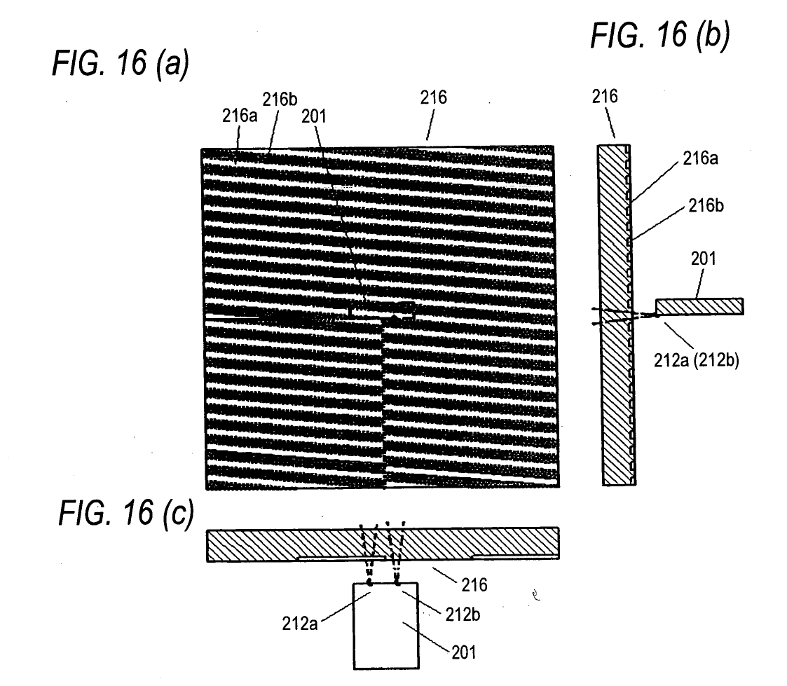

In the above-explained embodiment mode 5, the regions where the phases of the hills and the phases of the valleys in the grooves formed in the diffraction grating 202 are shifted have been set in order to cover both DVD and CD of the two-wavelength semiconductor laser 201. However, while this region is not required for the CD which originally uses the three beams, the regions where the phases of the hills and the phases of the valleys in the grooves formed in the diffraction grating 202 are shifted may be set only to DVD for using only one beam, namely the main beam 213. FIG. 16(a) to FIG. 16(c) are an upper view, a side view, and a front view, which enlargedly show a two-wavelength semiconductor laser and a diffraction grating according to an embodiment mode 6 of the present invention.

An entire structure of an optical system is identical to that as explained in the embodiment mode 5, except that the diffraction grating 202 is replaced by a diffraction grating 216. This diffraction grating 216 is arranged in such a manner that regions where phases of hills and phase of valleys of grooves formed in this diffraction grating 216 are shifted have been set only on the side of the light emitting point 212a corresponding to a light source of a DVD in the two-wavelength semiconductor laser 201. Similar to the embodiment mode 5, a boundary between these two regions is directed from the light emitting point 212a of the two-wavelength semiconductor laser 201 via a center of laser light to the tangential direction of the circumference of the optical disk 210. Similarly, it is desirable that the phases of the hills are substantially reversed to the phases of the valleys. Since such a structure is employed, while the same characteristic for CD as the conventional characteristic is maintained, the light amount distribution of the side beams 214 along the tangential direction of the circumference can be widened only for DVD, and also, the production of the jitter components of the RF signal for DVD can be suppressed.

In this embodiment mode 6, one beam is used for the DVD purpose. Alternatively, in such an optical pickup apparatus where 1 beam and 3 beams are used in a mixture manner, the regions where the phases of the hills and the phases of the valleys of the grooves of the diffraction grating 216 are shifted may be set on the side of such a light emitting point of a light source which uses the 1 beam.

### Embodiment Mode 7

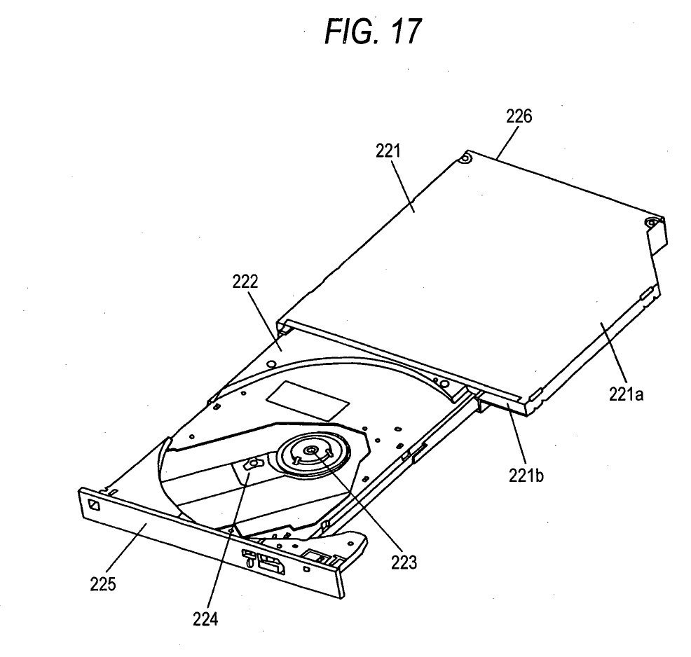

FIG. 17 is a perspective view for indicating an optical disk apparatus according to an embodiment mode 7 of the present invention. In FIG. 17, a housing 221 has been constructed by combining an upper housing 221a with a lower housing 221b. A tray 222 has been slidably provided with the housing 221. A spindle motor 223 and an optical pickup apparatus 224 have been provided on a tray 222, while this spindle motor 223 corresponds to a rotation driving means for rotating the optical disk 210. While the optical pickup apparatus 224 is equipped with the optical system indicated in FIG. 12 with employment of either the diffraction grating 202 shown in FIG. 13 or the diffraction grating 216 shown in FIG. 16, the optical pickup apparatus 224 performs at least one of an operation for writing information in the optical disk 210, and another operation for reading information from the optical disk 210. At this time, an optical intensity distribution on the optical disk 210 is indicated in FIG. 15(b). Also, a feed driving system (not shown) has been provided within the tray 222, and corresponds to a moving means for approaching and/or removing the optical pickup apparatus 224 within the spindle motor 223. A bezel 225 has been provided at a front edge plane of the tray 222, and has been arranged in such a manner that when the tray 222 is stored in the housing 221, this bezel 225 closes an entrance/exist port of the tray 222. A circuit board (not shown) has been provided inside the housing 221, or inside the tray 222, and an IC of a signal processing system, a power supply circuit, and the like have been mounted on this circuit board. An external connector 226 (not shown) is connected to a power supply/signal line which is provided in an electronic appliance such as a computer. Then, electric power is supplied via the external connector 226 to the optical disk apparatus, or an electric signal derived from an external unit is conducted to the optical disk apparatus, or an electric signal produced from the optical disk apparatus is sent to an electronic appliance, and the like.

As previously explained, such an optical disk apparatus can comprise the better recording/reproducing characteristic and can represent the stable operation, while this optical disk apparatus mounts thereon the optical pickup apparatus 224 having the optical system shown in FIG. 12 with employment of either the diffraction grating 202 indicated in FIG. 13 or the diffraction grating 216 shown in FIG. 16, or mounts thereon the optical pickup apparatus 224 indicating the light amount distribution as indicated in FIG. 15(b).

### Embodiment Mode 8

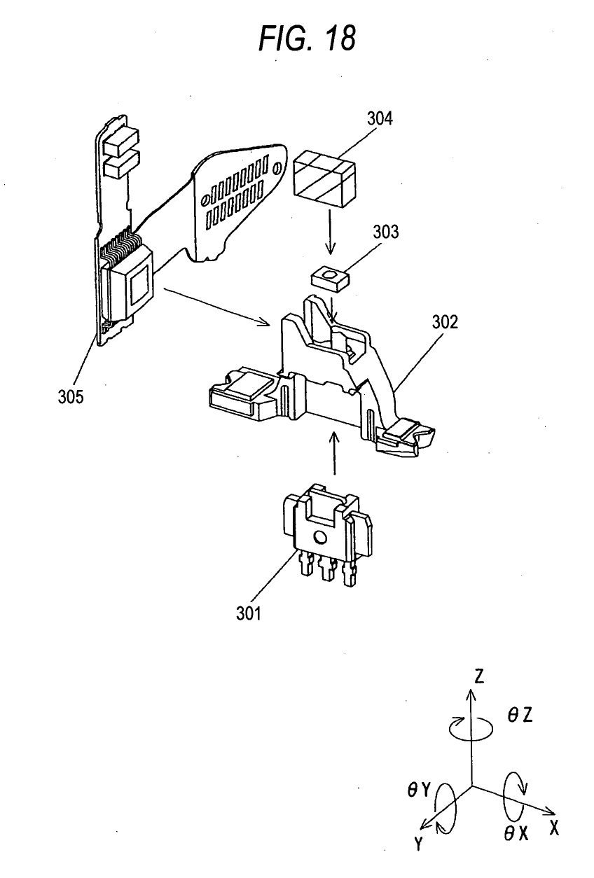

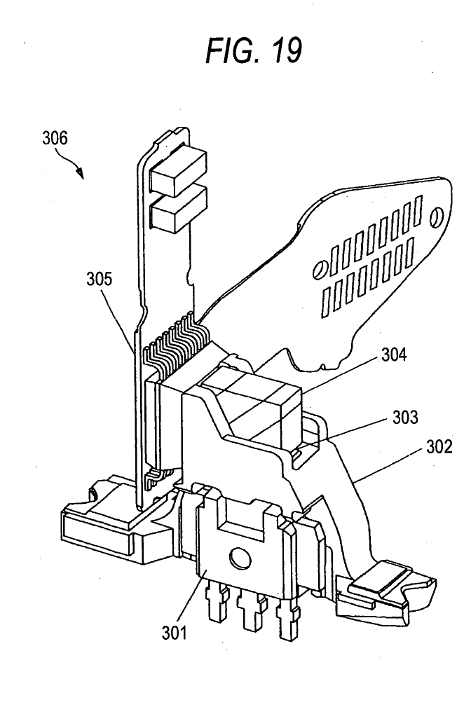

Referring now to drawings, an embodiment mode 8 of the present invention will be described. FIG. 18 is an exploded perspective view for showing a laser light source module of this embodiment mode 8. FIG. 19 is a perspective view for showing a structure of the laser light source module of the embodiment mode 8. In this embodiment mode 8, in a laser light source module 306, a laser light source 301, an optical element 303 and another optical element 304, and a light receiving unit 305 are arranged on a coupling base 302.

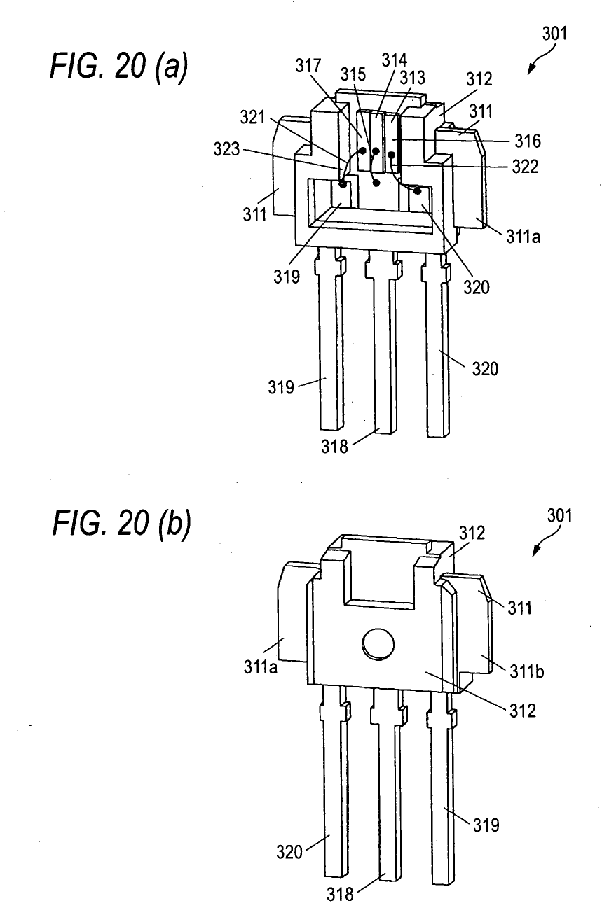

FIG. 20(a) is a front structural diagram of a laser light source 301 according to the embodiment mode 8, and FIG. 20(b) is a rear structural diagram thereof. As this laser light source 301, for example, such a frame laser light source shown in FIG. 20 is suitably employed. The frame laser light source functioning as the laser light source 301 has been arranged in such a manner that a portion of a plate 311 is covered by a mold member 312. The plate 311 is constituted by a plate-shaped member made of a metal material such as Cu, a Cu alloy, Ag, an Ag alloy, Al, an Al alloy, Fe, an Fe alloy, and the like. More preferably, a material having a better soldering material is coated on this plate-shaped member by means of plating, or vapor deposition. It should be noted that the frame 311 may be alternatively made of a material having a better thermal transfer characteristic and a higher electric conductivity, for example, an electric conductive ceramic. The plate 311 is equipped with side portions 311a and 311b which are projected to both sides of a mold 312. The laser light source 301 is mounted on the coupling base 302 by the side portions 311a and 311b. The side portions 311a and 311b radiate heat generated in the semiconductor laser element 314 to the coupling base 302.

A semiconductor laser element 314 has been provided via a sub-mount 313 having an insulating portion on the plate 311. This plate 311 has been electrically connected to an upper surface of the semiconductor laser element 314 by using an electric-conductive wire 315 made of such a material as Au. A laser light emitting plane of the semiconductor laser element 314 is arranged on the upper portion of the laser light source 301. The sub-mount 313 is formed by employing an insulating material. On a plane of the sub-mount 313 where the semiconductor laser element 314 is arranged, electrodes 316 and 317 have been formed in a separation manner, and the semiconductor laser element 314 has been fixed on these electrodes 316 and 317. The electrodes 316 and 317 have been electrically connected to the semiconductor laser element 314.

The semiconductor laser element 314 has been arranged in such a manner that light emitting points which emit light having a plurality of different wavelengths are arrayed parallel to each other on a single block. In this embodiment mode 8, such a semiconductor laser element 314 has been employed which emits both laser light having a wavelength “λ1” (about 650 nm) which is used in a DVD system, and laser light having a wavelength “λ2” (about 780 nm) which is employed in a CD system.

A terminal unit 318 is formed with the plate 311 in an integral body. In other words, the plate 311 has been electrically connected to this terminal unit 318. Also, terminal units 318 and 320 are provided to be electrically separated from the plate 311 and the terminal unit 318. The plate 311, the terminal units 319 and 320, which have been formed with the terminal unit 318 in the integral form, are fixed, while are electrically separated from each other by a mold member 312. The terminal unit 319 is electrically connected to the electrode 317 through the conductive wire 321, while the terminal unit 320 is electrically connected to the electrode 316 through the conductive wire 322.

The terminal unit 318 is grounded, the terminal unit 319 is connected to a circuit which supplies such a current for emitting the laser light having the wavelength λ1, and the terminal unit 320 is connected to a circuit which supplies such a current for emitting the laser light having the wavelength λ2. In such a case that the semiconductor laser element 314 emits the laser light having the wavelength “λ1” which performs at least one of recording and reproducing information with respect to an optical disk of a DVD series, a current is supplied to the terminal unit 319, the wire 321, the electrode 317, the semiconductor laser element 314, the wire 315, the plate 311, and the terminal unit 318 in this order. On the other hand, in such a case that the semiconductor laser element 314 emits the laser light having the wavelength “λ2” which performs at least one of recording and reproducing information with respect to an optical disk of a CD series, a current is supplied to the terminal unit 320, the wire 322, the electrode 316, the semiconductor laser element 314, the wire 315, the plate 311, and the terminal unit 318 in this order.

It should be noted that the semiconductor laser element 314 has been arranged in such a manner that light emitting points which emit light having a plurality of different wavelengths are arranged parallel to each other on a single block. However, this semiconductor laser element 314 may alternatively employ the following structure. That is, the semiconductor laser element 314 having a light emitting point which emits laser light having a single wavelength within one block is arranged on the sub-mount 313, a plurality of the above-described semiconductor elements 314 are arranged in proximity to each other on the plate 311, and thus, laser light having the different wavelengths may be emitted. In this alternative case, although there are some possibilities that the dimension of the laser light source 301 may be more or less increased, the semiconductor laser element 314 which may emit such laser light having arbitrarily different wavelengths is mounted, so that the laser light source arrangement capable of emitting a plurality of luminous fluxes having largely different wavelengths may be easily constructed.

Although the wavelengths of the laser light emitted from the laser light source 301 have been selected to be two wavelengths, namely, “λ1 (approximately 650 nm)” for the DVD purpose, and “λ2 (approximately 780 nm)” for the CD purpose, the present invention is not limited only thereto. For instance, these light emitting points may be alternatively combined with a light emitting point for emitting such a laser light having a wavelength of approximately 405 nm for a BD (blue ray disk) and an HD DVD (high definition DVD) which function as next-generation DVDs.

The mold member 312 must be necessarily made of an insulating material, while a resin material and a ceramic material may be suitably employed. More specifically, the resin material is desirable, since the laser light source 301 can be very easily manufactured. Also, such a resin material is more preferable which comprises a high heat resistance characteristic (higher, or equal to 250 degrees) and in which an occurrence of burrs is decreased. To this end, in this embodiment mode 8, PPS (polyphenylene sulfide) was used. Alternatively, an epoxy resin, a urethane resin, liquid crystal polymer, and the like may be employed.

As previously explained, the mold member 312 fixes the plate 311, and the terminal units 319 and 320, which have been formed with the terminal unit 318 in the integral body. When the laser light source 301 is viewed from the front plane thereof, the mold member 312 has contained a wall portion 323 whose laser light emitting plane is opened. Within this wall portion 323, the sub-mount 313, the semiconductor laser element 314, a portion of the plate 311, the wires 315, 321, 322, a portion of the terminal unit 319, and a portion of the terminal unit 320 are arrayed. Also, when the laser light source 301 is viewed from the rear plane thereof, the mold member 312 has been provided in such a manner that a portion of such a plane of the plate 311 is exposed, and this plane is located opposite to the side where the semiconductor laser element 314 has been provided both the mold member 312 on the front surface side and the mold member 312 on the rear surface side have been formed in an integral form.

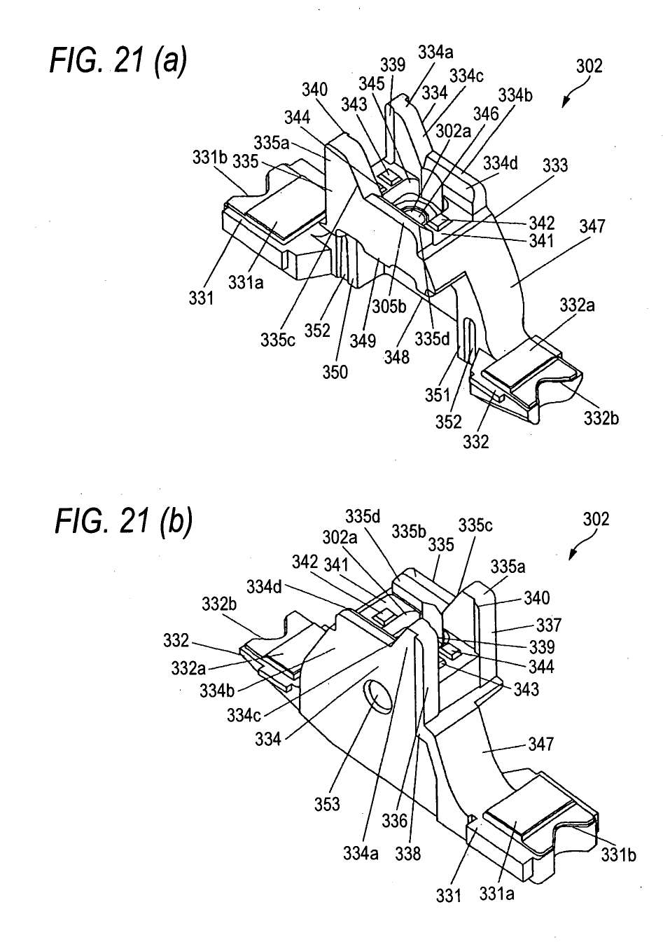

Next, the coupling base 302 will now be explained. FIG. 21(a) is a perspective view for showing a rear surface of the coupling base 302 according to the embodiment mode 8, and FIG. 21(b) is a perspective view for indicating a front surface thereof. A material used to form this coupling base 302 requires a relatively light weight in combination with a shape processing characteristic capable of realizing a high-precision completion dimension, and a better heat radiating characteristic. For instance, Zn, a Zn alloy, Al, an Al alloy, Ti, a Ti Alloy, and the like may be preferably employed. In this embodiment mode 8, the coupling base 302 was formed by way of a Zn die-cast method, while considering a cost aspect, and the like.

A fixing portion 331 and another fixing portion 332 of the coupling base 302 fix the comprise coupling base 302 on a carriage of an optical pickup. A reference plane 331a and another reference plane 331a which abut against abutting planes of the carriage have been provided on the fixing portions 331 and 332, respectively. The abutting planes of the carriage have been provided at predetermined positions and predetermined angles with respect to the references of the carriage. Also, concave portions 331b and 332b having either substantially “V” shapes or substantially “U” shapes and having positioning functions are provided at outer edges of the fixing portions 331 and 332. These concave portions 331b and 332b may be used for the positioning purpose when the coupling base 302 is mounted on the carriage, and also, may be used as the reference portions when the laser light source 301, the light receiving unit 305, and the optical elements 303 and 304 are mounted on the coupling base 302. In the embodiment mode 8, such a direction of a normal line as to such a plane which is formed by the reference planes 331a and 332a corresponds to a Z-axis direction of FIG. 18; such a direction for connecting a vertex portion of the concave portion 331b to a vertex portion of the concave portion 332b corresponds to an X-axis direction; and also, such a direction which is located perpendicular to both the Z axis and the X axis corresponds to a Y-axis direction. A plane which is formed by the reference planes 331a and 332a corresponds to a reference position of the Z axis; and a center point between the vertex portion of the concave portion 331b and the vertex portion of the concave portion 332b corresponds to a reference position of the X axis and the Y axis. In other words, the reference planes are located over the X-Y plane. As previously explained, the references of the coupling base 302 are arranged by the reference planes 331a, 332a, and the concave portions 331b, 332b. It should also be noted that in this embodiment mode 8, the references of the coupling base 302 have been defined as the reference planes 331a, 332a, and the concave portions 331b, 332b. Alternatively, other portions may be employed as the references. In this case, positions and angles with respect to the carriage must be clearly defined.

Furthermore, in this embodiment mode 8, the coupling base 302 has been arrayed in such a manner that this coupling base 302 is directly mounted on the carriage. Alternatively, the coupling base 302 may be mounted via another member. In this alternative case, the reference planes 331a and 332a may firmly abut against an abutting plane of this another member, and also, when the coupling base 302 is mounted on the carriage, this abutting plane may be set at a predetermined position and a predetermined angle with reference to the reference of the carriage.

While a main body portion 333 which mounts thereon at least this laser light source 301, the light receiving unit 305, and the optical elements 303 and 304 has been provided between the fixing portions 331 and 332, both the fixing portions 331 and 332 are provided at both sides of the main body portion 333 in an integral body. It should also be noted that in this embodiment mode 8, the main body portion 333 has been formed with the fixing portions 331 and 332 in the integral body. Alternatively, such members corresponding to the fixing portions 331 and 332 may be provided as separate members, and these separate members corresponding to the fixing members 331 and 332 may be mounted on the main body portion 333 by employing any one of an adhering method, an engaging method, and a welding method. In this alternative case, the positions and the angles of the reference planes 331a, 332a, and of the concave portions 331b, 332b must be determined in accordance with a predetermined manner.

While one pair of side walls 334 and 335 located opposite to each other have been provided to stand on the main body portion 333, the optical elements 303 and 304 are arrayed between the side walls 334 and 335. While wall portions 334a and 334b are provided on the side wall 334, the height of the wall portion 334a is made higher than that of the wall portion 334b. Moreover, the wall portion 334a and the wall portion 334b have been coupled to each other by an inclined portion 334c. Similarly, while wall portions 335a and 335b are provided on the side wall 335, the height of the wall portion 335a is made higher than that of the wall portion 335b. Moreover, the wall portion 335a and the wall portion 335b have been coupled to each other by an inclined portion 335c. Also, a tapered portion 334d and another tapered portion 335d located opposite to each other have been provided on the wall portions 334b and 335b respectively. Also, the side walls 334 and 335 have been provided in such a manner that the wall portion 334a faces with the wall portion 335a, and the wall portion 334b faces with the wall portion 335b.

Also, substantially flat mounting portions 336 and 337 for mounting the light receiving unit 305 have been provided on the wall portions 334a and 335a located on the opposite side with respect to the inclined portions 334c and 335c. The light receiving unit 305 is arranged on these mounting portions 336 and 337. The mounting portions 336 and 337 are set in such a manner that these mounting portions 336 and 337 are defined at a predetermined angle (in case of this embodiment mode 8, right angle) with respect to the reference planes 331a and 332a, and also, are defined at a predetermined position and a predetermined angle (in case of this embodiment mode 8, right angle) with respect to the concave portions 331b and 332b. In other words, in this embodiment mode 8, a plane which is formed by the mounting portions 336 and 337 is located parallel to the Y-Z plane, and is located at a predetermined position with respect to the reference of the X axis. Also, the mounting portion 336 has been coupled to the mounting portion 337 at the bottom portion by a coupling portion having the substantially same plane.

The tapered portions 334d and 335d are employed in order that the optical elements 303 and 304 can be easily inserted, and these optical elements 303 and 304 are not scratched when the optical elements 303 and 304 are mounted on the main body portion 333. Furthermore, since these tapered portions 334d and 335d are provided, as will be explained later, when the optical element 304 is fixed on the main body portion 333 by an adhesive agent, the adhesive agent can be stored between these tapered portions 334d and 335d, and this optical element 304, and also, the adhesive strength can be increased.

A raised portion 338 which is raised rather than other portions has been formed on one side surface portion of the main body portion 333. The raised portion 338 has been provided from a bottom portion of the main body portion 333 on the side f the fixing portion 331 up to an upper portion of the side portion of the wall potion 334a between the fixed portions 331 and 332, and the upper portion has been formed with the mounting portion 336 in an integral body.

Since the raised portion 338 is provided so as to make the thickness of the main body portion 333 thicker, the mechanical strength of the main body portion 333 can be increased, so that flexures and deformations of the coupling base 302 can be suppressed. Furthermore, while the raised portion 338 is formed with the mounting portion 336 in the integral body, this raised portion 338 is provided over the upper portion of the side portion of the wall portion 334a so as to further mechanically reinforce the wall portion 334a, so that the light receiving unit 305 can be fixed under stable condition.

It should be understood that this raised portion 338 may not be provided, depending upon a material, a size, and a shape which constitute the coupling base 302. Also, in the case that the raised portion 338 is provided, the shape of the raised portion 338 is not limited only to the substantially “I-shape” shown in this embodiment mode 8, but may be realized by a substantially “T-shape”, a substantially circular shape, a substantially rectangular shape, a substantially “C-shape”, a substantially ellipse shape, a substantially “F-shape”, a substantially “E-shape”, and the like.

Also, a concave portion 339 which has reached to an edge portion has been provided on the wall portion 334a, and a raised portion 340 has been provided on the wall portion 335a. This reason is given as follows (will be explained later in detail): That is, when the light receiving unit 305 is fixed on the mounting units 336 and 337 by employing an adhesive agent, or the like, this adhesive agent can be hardly reached to the optical elements 303 and 304. As previously explained, since the wall portion 334a has been formed with the raising portion 338 formed with the mounting portion 336 in the integral body, a sufficiently large area of the mounting portion 336 can be obtained, and thus, the concave portion 339 is formed. Since the raised portion 338 is not provided on the wall portion 335a, another raised portion 340 is formed in order to secure the area of the mounting portion 337. It should also be noted that either the concave portion 339 or the raised portion 340 may not be provided, depending upon the technical specification.

A mounting portion 341 for mounting thereon the optical element 304 has been provided between the side walls 334 and 335 of the main body portion 333. Athrough hole 302a has been formed between the mounting portion 341 and a space portion 348. The through hole 302a has been formed by coupling a large diameter portion 345 to a small diameter portion 346. A sectional plane of the large diameter portion 345 located close to the mounting portion 341 is large. A sectional plane of the small diameter portion 346 located close to the space portion 348 is small. An upper plane of the small diameter portion 346 is set in such a manner that this upper plane is located parallel and at a predetermined height with respect to the reference planes 331a and 332a. The optical element 303 is arranged at an inner portion of the large diameter portion 345 of the upper plane of the small diameter portion 346. To this end, the large diameter portion 345 comprises such a sectional plane and a depth by which the optical element 303 can be stored. It should also be understood that the small diameter portion 346 may be replaced by a projection for mounting thereon the optical element 303, and also, the through hole 302a is not formed in both the large diameter portion 345 and the small diameter portion 346, but may be replaced by a straight structure.

Projection portions 342, 343, and 344 have been formed on a peripheral portion of an opening portion of a through hole 302a of the mounting portion 341 in an integral manner, or a separate manner with respect to the mounting portion 341. When these projection portions 342, 343, 344 are separately provided, projection pieces are mounted on the mounting portion 341 by employing any one of an adhering manner, a loose engaging manner, an engaging manner, and a weldering manner. The relatively large projection portion 342 has been arranged on the side of the wall portions 334a and 335a, whereas the relatively small projection portions 343 and 344 have been arranged in a parallel manner on the side of the wall portions 334b and 335b. A plane which is formed on upper planes of the projection portions 342, 343, 344 is set to be parallel and to have a predetermined height with respect to the reference planes 331a and 332a. The optical element 304 is arranged on the upper planes of these projection portions 342, 343, 344. A height defined from the upper plane of the small diameter portion 346 up to the upper planes of the projection portions 342, 343, 344 is made higher than the height of the optical element 303. As a result, the optical element 304 can be separated from the optical element 303 by a predetermined distance.

It should also be noted that the optical element 304 has been supported by the projection portions 342, 343, 344 at three points, and could be supported under stable attitude. However, the present invention is not limited only to the method how to arrange the projection portions and the shapes thereof. Also, the plane which is formed by the upper plane of the small diameter portion 346 and the upper plane of the projection portions 342, 343, 344 has been located parallel to the reference planes 331a and 332a. Alternatively, this plane need not be positioned parallel thereto depending upon an arrangement of an optical system, but may be located at a predetermined angle with respect to the reference planes 331a and 332a. Further, sectional shapes of these projection portions 342, 343, 344 may be alternatively made of properly selected shapes, for instance, substantially circular shapes, substantially rectangular shapes, substantially polygon shapes, and substantially triangular shapes, depending upon technical specifications and forming steps.

In this embodiment mode 8, although the projection portions 342, 343, 344 have been provided, the present invention is not limited thereto, but such an arrangement may be alternatively provided in which the optical element 304 is arranged on the upper plane of the large diameter portion 345. In this alternative case, a height difference between the upper plane of the small diameter portion 346 and the upper plane of the large diameter portion 345 is made higher than the height of the optical element 303, and also, the upper plane of the large diameter portion 345 is set to be located parallel and to have a predetermined height with respect to the reference planes 331a and 332a.

Alternatively, the through hole 302a may be arranged in which a medium diameter portion is formed between the large diameter portion 345 and the small diameter portion 346, and two stepped portions are formed. Also, this through hole 302a may be alternatively arranged in such manner that the diameter thereof is continuously decreased in accordance with such a condition that the through hole 302a is separated apart from the mounting portion 341. In other words, in the through hole 302a, the sectional area of the opening on the side of the mounting portion 341 is made wider than the sectional area of the opening on the side of the space portion 348. Furthermore, another arrangement may be alternatively employed in which the large diameter portion 345, the small diameter portion 346 are provided at a half way portion of the through hole 302a from the side of the mounting portion 341.

In the case that the sectional shape of the through hole 302a is such a shape as a rectangular sectional shape, or a polygon sectional shape other than a circular shape, this shape implies that the sectional area of the large diameter portion 345 is large and the sectional area of the small diameter portion 346 is small.

On the side of the bottom portion of the mounting portion 341, the main body portion 333 is equipped with a supporting portion 347 and a space portion 348 which arranges the laser light source 1. The supporting portion 347 connects the mounting portion 341 with the fixing portions 331, and 332 in an integral body. The supporting portion 347 is formed with the side wall 334 in an integral body. A projection portion 349 has been formed with the side wall 335 in an integral body, which is projected from the mounting portion 341 toward the space portion 348. The space portion 348 corresponds to such a space which is surrounded by the fixing portions 331, 332, the supporting portion 347, and the mounting portion 341.

The space portion 348 has been communicated with the through hole 302a. A joint portion 350 and another joint portion 351 which fix the side portions 3111a and 311b of the laser light source 301 have been provided on the supporting portion 347 facing with the space portion 348. A plane which is formed by the joint portions 350 and 351 is located at a predetermined angle (in this embodiment mode 8, right angle) with respect to the reference planes 331c and 332b, and further, is located at a predetermined position and a predetermined angle (in this embodiment mode 8, parallel) with respect to the concave portions 331b and 332b. In other words, the plane which is formed by the joint portions 350 and 351 is located parallel to the Z-X plane, and at a predetermined position with respect to the reference of the Y axis. The coupling base 302 of this embodiment mode 8 comprises a concave portion 352 on the joint portions 350 and 351 located near this coupling base 302, against which the side portions 311a and 311b abut. Since such a fixing member as cream solder is arranged in the concave portion 352 and is melted, the fixing member may be properly entered into a space between the joint portions 350 and 351, and the side portions 311a and 311b, so that fixing operation can be firmly carried out.

It should also be understood that in FIG. 21, the concave portion 352 comprises such a groove shape that the concave portion 352 penetrates through the lower portion side, but does not penetrate through the upper portion. Alternatively, this concave portion 352 may penetrate through the upper portion. Also, although the concave portion 352 has been made of such a groove shape, the joint portions 350 and 351 except for such a portion abutting against the side portions 311a and 311b may be alternatively formed in concave shapes. Further, as to the shape of the groove, the bottom plane thereof may be made as a flat plane, or a non-flat plane such as a round shape. In addition, the concave portion 352 may be alternatively located at a position which is slightly separated from the side portions 311a and 311b, and conversely, may be located over the side portions 311a and 311b.

Also, the through hole 353 communicated with the space portion 348 has been provided on the side where the raised portion 338 of the main body portion 333 is provided, and when the positioning operation of the laser light source 301 is carried out, this through hole 353 can be monitored. Although the manufacturing steps may become more or less complex, this through hole 353 may be alternatively covered by transparent glass, or a resin film. Alternatively, either a transparent resin or glass may be embedded in this through hole 353.

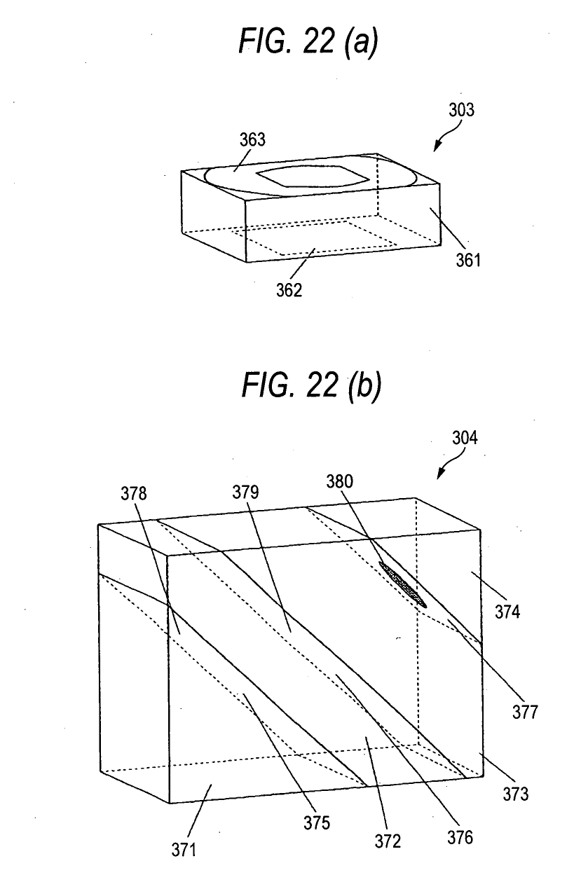

Next, a description is made of the optical elements 303 and 304. FIG. 22(a) is a structural diagram for showing the optical element 303 according to the embodiment mode 8, and FIG. 22(b) is a structural diagram of the optical element 304.

The optical element 303 is equipped with a base body 361 having a substantially rectangular solid shape and made of transparent optical glass; a diffraction grating 362 provided on a plane of the base body 361 located opposite to the laser light source 301, which separates light emitted from the laser light source 301 into three laser beams; and an aperture limiting film 363 provided on such a plane (namely, plane opposite to optical element 304) which is located opposite to the plane of the base body 361, which is located opposite to the laser light source 301.

The aperture limiting film 363 is constructed in such a manner that, for example, an SiO₂ film and at least one of an Si film and a Ti film are alternately stacked on each other plural times. The aperture limiting film 363 comprises an aperture portion, absorbs light which is entered to the comprise aperture limiting film 363, and light entered to the aperture portion penetrates through this aperture limiting film 363. In other words, since only the laser light entered to the aperture portion of the aperture limiting film 363 passes through this aperture limiting film 363, such a laser light having a desirable sectional shape can be obtained. In this embodiment mode 8, although the aperture limiting operation has been carried out by employing the aperture limiting film 363, an aperture limiting portion may be merely provided. For instance, a sheet-shaped aperture limiting member may be attached to the base body 361, another non-transparent block may be attached thereto, or the dimension of the sectional area of the through hole 302a may be adjusted. The aperture shape of the aperture limiting film 363 may be selected from a substantially rectangular shape, a circular shape, an ellipse shape, an oval shape, and a polygon shape, depending upon optical designing conditions of optical pickups. Also, although the base body 361 has been formed in the substantially rectangular solid shape, this shape may be made in a cubic shape, or an ellipse cylindrical shape.

Although the diffraction grating 362 has been provided on the surface portion of the base body 361, either a transparent substrate or a transparent film which are made of the same material as that of the base body 361 may be provided on the plane where the diffraction grating 362 is formed, or a transparent protection film may be provided on this plane in order to protect this diffraction grating 362. Also, this diffraction grating 362 may be alternatively realized as such a wavelength selective type diffraction grating. This wavelength selective type diffraction grating may function as the diffraction grating only for the laser light having the wavelength λ2 for the CD purpose, which is required to be separated into three laser beams, but may not function as the diffraction grating only for the laser light having the wavelength λ1 for the DVD purpose, which is required to be 1 laser beam.

The optical element 304 has been made in the substantially rectangular solid shape by joining blocks 371, 372, 373, 374 to each other which are manufactured by either transparent optical glass or an optical resin by employing glass, or a ultraviolet hardening adhesive agent. The optical element 304 contains inclined planes 375, 376, 377, which are located parallel to each other. While the inclined plane 375 has been formed between the blocks 371 and 372, this inclined plane 375 corresponds to a joint plane between the blocks 371 and 372. A polarized light separating film 378 is formed on at least one plane of these blocks 371 and 372. This polarized light separating film 378 comprises such an optical characteristic that in the laser light having the wavelength λ1 for the DVD purpose, P-polarized light is substantially penetrated and S-polarized light is reflected, whereas in the laser light having the wavelength λ2 for the CD purpose, both P-polarized light and S-polarized light are substantially penetrated. While the inclined plane 376 has been formed between the blocks 372 and 373, this inclined plane 376 corresponds to a joint plane between the blocks 372 and 373. A polarized light separating film 379 is formed on at least one plane of these blocks 371 and 373. This polarized light separating film 379 comprises such an optical characteristic that in the laser light having the wavelength λ2, P-polarized light is penetrated and S-polarized light is reflected, whereas in the laser light having the wavelength λ1, both P-polarized light and S-polarized light are substantially penetrated. While the inclined plane 377 has been formed between the blocks 373 and 374, this inclined plane 377 corresponds to a joint plane between the blocks 373 and 374. A hologram 380 has been provided on at least one plane of the blocks 373 and 374, and is used in a servo.

It should also be understood that in this embodiment mode 8, although the optical element 304 has been constituted by the 4 blocks, this optical element 304 may be alternatively arranged by 3, or less blocks, or 5, or more blocks. As a result, two, or less inclined planes may be contained in the optical element 304, or 4, or more inclined planes may be built in this optical element 4.

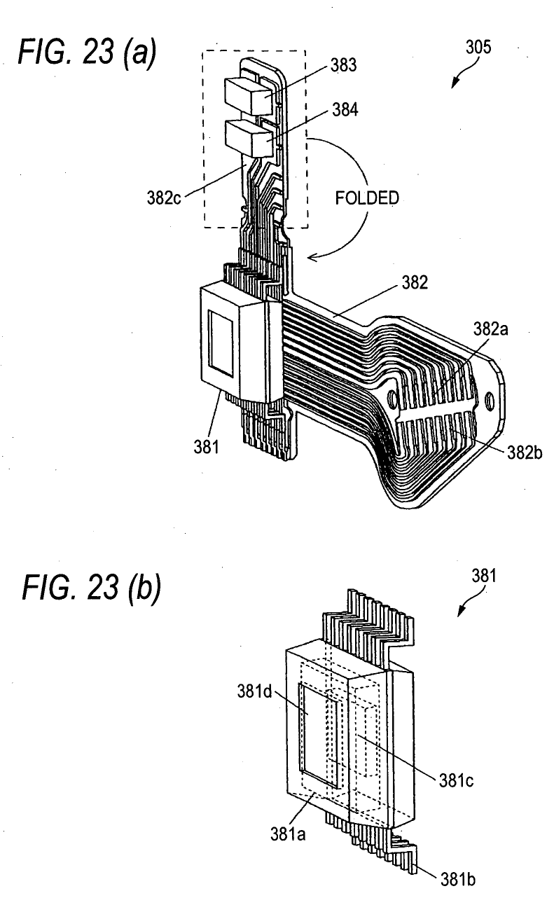

Next, the light receiving unit 305 will now be described. FIG. 23(a) is a structural diagram for showing the light receiving unit 305 of the embodiment mode 8, and FIG. 23(b) is a structural diagram for showing a light receiving element body.

The light receiving unit 305 is equipped with a light receiving element body 381 into which reflection light from an optical disk is entered. Although not being employed in this embodiment mode 8, such a laser light which is emitted from the laser light source 301 but is not traveled through the optical disk may be further entered to the light receiving element body 381 in order to control a light amount of the optical disk. Also, the light receiving unit 305 in the embodiment mode 8 is equipped with a board 382 which mounts thereon the light receiving element body 381, and capacitors 383 and 384 which are mounted on the board 382 so as to stabilize a power supply voltage.

The light receiving element body 381 contains a light receiving sensor 381c which is provided with a photodetector and the like within a case 381a constructed of a mold resin. In the light receiving sensor 381c, a plurality of photo detectors are arranged in a predetermined pattern in accordance with a technical specification and the like. The light receiving sensor 381c converts reflection light from the optical disk into an electric signal, while this reflection light is entered into the photodetector. A plurality of leads 381b are exposed from the case 381a outside this case 381a. The leads 381b are electrically connected to the light receiving sensor 381c. The leads 381b may transfer necessary electric power to the internal light receiving sensor 381c, and/or may conduct an electric signal converted by the light receiving sensor 381c to an external unit.

The case 381a is equipped with a window 381d located opposite to the light receiving sensor 381c. The window 381d is shielded by a transparent material in order to prevent dust. At least, the light which is entered to the photodetector of the light receiving sensor 381c is not shielded, but also, intensity of the light is not weakened by this window 381d. Since the entire portion of the case 381a is molded by such a transparent resin as a clear resin, the transparent window 381d may be provided without providing a separate member. In this embodiment mode 8, while the case 381a is formed by the transparent clear resin, the portion of the window 381d is made thinner by stepping down this window portion rather than the peripheral portion. Furthermore, in order to avoid that unwanted light such as stray light is entered from any portion other than the window 381d into the photodetector of the light receiving sensor 381c, embossment is made on the portion other than the window 381d so as to become non-transparent. Alternatively, instead of this embossment, a surface roughness may be made coarse so as to become non-transparent. Also, while the portion other than the window 381d is constituted by an opaque resin and ceramics which never penetrate therethrough light, the window 381d may be made of transparent glass and a transparent resin film may be provided. Further, in the case that the dust proof is performed by way of another means, any member is not provided on the portion of the window 381d, and the photodetector of the light receiving sensor 381c may be exposed.

In this embodiment mode 8, as to the board 382, such a board having a flexible characteristic as a flexible printed board, and a multi layer flexible printed board have been employed. It should also be understood that when the board 382 need not have the flexible characteristic, as the board 382, such a board having a certain degree of elasticity, or a certain degree of rigidness may be alternatively employed, for instance, a ceramic board, a ceramic multi layer board, a glass epoxy board, and a glass epoxy multi layer board may be alternatively employed.

While the shape of the board 382 is made of either a substantially L-shape or a substantially T-shape, this board 382 is equipped with a connection unit 382a having an external connection terminal 382b for an external connection purpose, and a mounting unit 382c for mounting thereon various components such as the light receiving element body 381, capacitors 383, 384, and the like. The mounting unit 382c and the connection unit 382a are formed in an integral body at a substantially right angle, or a pre-selected angle. It should be noted that although the board 383 is made of either the substantially L-shape or the substantially T-shape in this embodiment mode 8, the board 382 may apparently employ other shapes, depending upon a technical specification.

In this embodiment mode 8, the mounting unit 382c and the connection unit 382a have been formed in the integral body. Alternatively while the mounting unit 382c and the connection unit 382a are separately manufactured, after the respective members have been mounted on the mounting unit 382c, the connection unit 382a may be mounted on the mounting unit 382c. Also, while such a simple shape as a disk, a rectangular plate, and a belt-shaped plate is employed as the board 382, the external connection terminal 382b and the light receiving element body 381 may be provided on the board 382.

In this embodiment mode 8, a width of a region where the external connection terminal 382b is arranged, namely, a width of a tip portion of the connection unit 382a is made wider than the widths of other portions so as to be easily connected to other circuits, and the like.

The capacitors 383 and 384 are provided in order that an operational amplifier and the like employed in the light receiving element body 381 are oscillated. As these capacitors 383 and 384, a ceramic capacitor can be suitably employed. However, a multi layer ceramic capacitor, a tantalum capacitor, an electrolytic capacitor, and the like may be alternatively employed, depending upon a technical specification.

Next, a description is made of a method for manufacturing a laser light source module according to the embodiment mode 8.

That is, an adhesive agent such as an instantaneous adhesive agent is coated on at least one of an upper plane of the small diameter portion 346 of the through hole 302a of the coupling base 302 and such a plane of the optical element 303 where the diffraction grating 362 is provided (namely, side opposite to side where aperture limiting film 363 is provided). Next, the optical element 303 is inserted into the large diameter portion 345, and is moved along both an X-axis direction and a Y-axis direction of FIG. 18, and then, is close contacted to the upper plane of the small diameter portion 346 located at a predetermined position with respect to the reference positions of both the X axis and the Y axis so as to be fixed. The through hole 302a stores thereinto the optical element 303.

Next, the optical element 304 is positioned on the mounting unit 341 this optical element 304 is arranged on the projection portions 342, 343, 344 in such a manner that the side portion thereof are sandwiched by the side walls 334 and 335. Also, the optical element 304 is moved along the X-axis direction and the Y-axis direction of FIG. 18, is adjusted to a predetermined position with respect to the reference positions of the X axis and the Y axis, and then, is close contacted to the upper planes of the projection portions 342, 343, 344. An adhesive agent is supplied between the side walls 334, 335, and the optical element 304 so as to fix the positioned optical element 304 on the coupling base 302 within a short time. As the adhesive agent, a ultraviolet hardening adhesive agent, and such an adhesive agent having a water absorbing characteristic, which is instantaneously hardened may be suitably used. Since there is a gap between the optical elements 303 and 304, it is possible to avoid an occurrence of aberration of light which is caused by the provision of the adhesive agent between the optical elements 303 and 304, and the optical characteristic can be improved.

As previously explained, the optical elements 303 and 304 are fixed at the predetermined positions, the predetermined heights, and the predetermined angles with respect to the reference planes 331a and 332a, and the concave portions 331b and 332b, which correspond to the reference of the coupling base 302.

Next, the reference planes 331a and 332a of the coupling base 302 abut against a reference plane of a manufacturing apparatus. In this case, the positions of the concave portions 331b and 332b are fitted to the reference position of the manufacturing apparatus. The laser light source 301 is arranged in the space portion 348 of the coupling base 302, and the side portions 311a and 311b abut against the joint portions 350 and 351. Also, the case 381a of the light receiving unit 305 abuts against mounting portions 336 and 337 of the side walls 334 and 335. In this abutment, a ultraviolet hardening adhesive agent has been coated on planes of at least any one of the light receiving unit 305 and the mounting portions 336 and 337. While the light emitting point for projecting the laser light having the wavelength “λ1” for the DVD purpose emits the light which is provided in the laser light source 301, this light emission is monitored by a CCD camera mounted on the above-described manufacturing apparatus. While the CCD camera is provided at a predetermined position and a predetermined angle with respect to both the reference position and the reference plane of the manufacturing apparatus, this CCD camera can grasp a light amount distribution of laser light emitted from the light emitting point of the laser light source 301. In other words, in this embodiment mode 8, the CCD camera can grasp such a light amount distribution as to such a position where the collimator lens is present in the case that the laser light source module is mounted via the coupling base 302 on the optical pickup. Furthermore, such a position which constitutes the center of this collimator lens has been previously defined. That is to say, the position which constitutes the center of the collimator lens has been previously defined with respect to the reference of the coupling base 302.

In the case that the center position of this virtual collimator lens is projected to the laser light source 301, this virtual center position has been set to be located between the light emitting point for emitting the laser light having the wavelength “λ1” and the light emitting point for emitting the laser light having the wavelength “λ2.” This position may be changed between the light emitting point for emitting the laser light having the wavelength “λ1” and the light emitting point for emitting the laser light having the wavelength “λ2.”

The CCD camera accumulates light amounts of laser light within such a region which is limited by a predetermined aperture within a field of this CCD camera so as to calculate a gravity position. A calculation is made of a difference between the gravity position of the laser light and the position within the field of the CCD camera which constitutes the center of the virtual collimator lens, which has been defined with respect to the previously calculated reference of the coupling base 302. In the case that it is so judged that there is the difference, the laser light source 301 is rotated along a direction of “θY” shown in FIG. 18 while the light emitting point for emitting the laser light having the wavelength λ1 of the laser light source 301 is set to the rotation center. Then, both the gravity position of the light amount distribution of the laser light having the wavelength “λ1”, and the position within the field of the CCD camera which constitutes the center of the virtual collimator lens are adjust so as to be entered into a predetermined range.

If this predetermined range is converted based upon the distance from the light emitting point for emitting the laser light having the wavelength λ1 up to the center of the virtual collimator lens and the converted range is defined within +0.2 degrees to −0.2 degrees, then the adjusting time can be shortened, and, a positional adjustment with respect to the collimator lens and also a positional adjustment with respect to the objective lens can be readily carried out (will be discussed later). If the converted range is defined within ±0.15 degrees, then the adjusting time does not become so long and the precision in the adjustment may be secured, so that both a better recording characteristic and a better reproducing characteristic can be secured. Furthermore, if the converted range is defined within ±0.1 degree, although the adjusting time becomes slightly long, since the better adjusting precision may be obtained, both the better recording and reproducing characteristics can be obtained under stable condition. As explained above, the center of the light amount distribution of the light which is projected from the light emitting point for emitting the laser light of the wavelength λ1 is directed to the direction of the center position of the virtual collimator lens, which is slightly shifted with respect to the reference of the coupling base 302.

In the embodiment mode 8, the center of the light amount distribution of the laser light has been set to the gravity center of the light amount distribution of the laser light where the calculation result may become stable. However, the present invention is not limited only to this gravity center. For example, such a position which indicates a maximum light amount of a light amount distribution may be set as the center of the light amount distribution. In this alternative case, in order to reduce an adverse influence caused by fluctuations of the respective measuring points in the light amount measurement, it is desirable to calculate an approximate curve of the light amount distribution.

Also, in the embodiment mode 8, the laser light source 301 has been rotated along the direction of “θY” shown in FIG. 18 so as to perform the adjustment. This direction corresponds to the radial direction of the optical disk. Since the adverse influence caused by the shift in the light emitting direction of the laser light having the wavelength “λ1,” along the radial direction of the optical disk is larger than that of the tangential direction of the circumference, the laser light source 301 is rotated along the direction of “θY.” As a consequence, assuming now that the adverse influence of the shift along the tangential direction of the circumference becomes larger than the radial direction, it is preferable to rotate the laser light source 301 along another direction of “θZ.” Also, if the adverse influences of the shifts along both the radial direction and the tangential direction are large, then it is preferable to arrange that the laser light source 301 is rotated along both the radial and tangential directions.

Next, the positioning adjustment of the light receiving unit 305 is carried out. A reflection mirror has been mounted on the manufacturing apparatus, and this reflection mirror reflects the laser light emitted from the laser light source 301 in a similar manner to an optical disk. The light emitting point of the laser light source 301 which projects the laser light having the wavelength λ2 emits the light, and the light reflected by the reflection mirror is entered to the light receiving unit 305. While the case 381a of the light receiving unit 305 continuously abuts against the mounting units 336 and 337, this case 381a is moved along the Y-axis direction and the X-axis direction, and thus, the position of the light receiving unit 305 is determined in such a manner that an S-shaped curve of a focusing error signal outputted from the light receiving sensor 381c of the light receiving unit 305 may become a predetermined value and a predetermined shape.

Next, the light emitting point for projecting the laser light having the wavelength λ2 emits the laser light. While the laser light source 301 continuously abuts against the joint portions 350 and 351, this laser light source 301 is moved along the X-axis direction of FIG. 18. A balance of tracking error signals is adjusted so as to determine the position of the laser light source 301 along the X-axis direction, while these tracking signals are outputted by converting the light entered to the respective photo detectors of the right receiving sensor 381c of the light receiving unit 305.

Next, the light emitting point for projecting the laser light having the wavelength λ1 emits the laser light. While the laser light source 301 continuously abuts against the joint portions 350 and 351, this laser light source 301 is moved along the Z-axis direction of FIG. 18. The position of the laser light source 305 is determined along the Z-axis direction in such a manner that a focal point may be formed on the recording plane of the optical disk when focusing error signals outputted from the light receiving sensor 381c of the light receiving unit 305 comprise predetermined values. When the positioning adjustment is completed, cream solder is coated on the concave portion 352, and then, this cream solder is melted by irradiating laser light onto this cream solder so as to fix the laser light source 301 on the coupling base 302. Finally, a fine adjustment as to the position of the light receiving unit 305 is carried out, and ultraviolet rays are irradiated in order to fix the light receiving unit 305 on the coupling base 302.

In this embodiment mode 8, while the cream solder is employed, this cream solder is melted and solidified so as to fix the laser light source 301 on the coupling base 302. Thereafter, the ultraviolet hardening adhesive agent is hardened by irradiating thereto ultraviolet rays so as to fix the light receiving unit 30 on the coupling unit 302. As previously explained, there a great possibility that heat may be applied to the ultraviolet hardening adhesive agent before this ultraviolet hardening adhesive agent is hardened. As a result, such a ultraviolet hardening adhesive agent having a superior heat resistance characteristic under such a condition before being hardened may be preferably employed. Also, instead of the cream solder, the ultraviolet hardening adhesive agent may be employed. In this case, when the laser light source 301 is fixed on the coupling base 302, it is desirable to set that ultraviolet rays are not leaked to the ultraviolet hardening adhesive agent which fixes the light receiving unit 305 on the coupling base 302. If so, then the very fine adjustment between the light receiving unit 305 and the coupling base 302 can be carried out, and further, the ultraviolet hardening adhesive agent having the superior heat resistance characteristic before being hardened is no longer required which fixes the light receiving unit 305 on the coupling base 302.

As previously explained, as to the laser light source module 306 of this embodiment mode 8, the laser light source 301 has been arranged in the coupling base 302 in such a manner that the projection direction of the laser light having the wavelength “λ1” for the DVD purpose, which is emitted from this laser light source 301, is directed to a predetermined axis with respect to the reference of the coupling base 302. This reference of the coupling base 302 corresponds to both the reference planes 331a and 332a, and the concave portions 331b and 332b. The reference planes 331a and 331b abut against the abutment plane of the carriage of the optical pickup. As a consequence, the laser light having the wavelength λ1 and emitted from the laser light source 301 may be projected to the main body of the optical pickup, while having a smaller fluctuation along the projection direction. As a result, even when the laser light source module 306 is assembled as the optical pickup, the fluctuation in the balances of the laser light which is entered to the respective photo detectors provided in the light receiving sensor 381c can be kept small.

Also, any of the optical elements 303 and 304, and also, the light receiving unit 305 have been assembled, while the reference planes 331a and 332a, and also, the concave portions 331b and 332b are employed as the reference. As a result, a fluctuation in the assembling dimensions is small.

Also, the projection direction of the laser light having the wavelength λ1 for the DVD purpose is fitted to the predetermined direction with respect to the reference planes 331a and 332a, and further, the electric signals outputted from the light receiving sensor 381c of the light receiving unit 305 are balanced in correspondence with the laser light having the wavelength λ2 for the CD purpose, so that both the characteristic for the DVD purpose and the characteristic for the CD purpose can be satisfied.

### Embodiment Mode 9

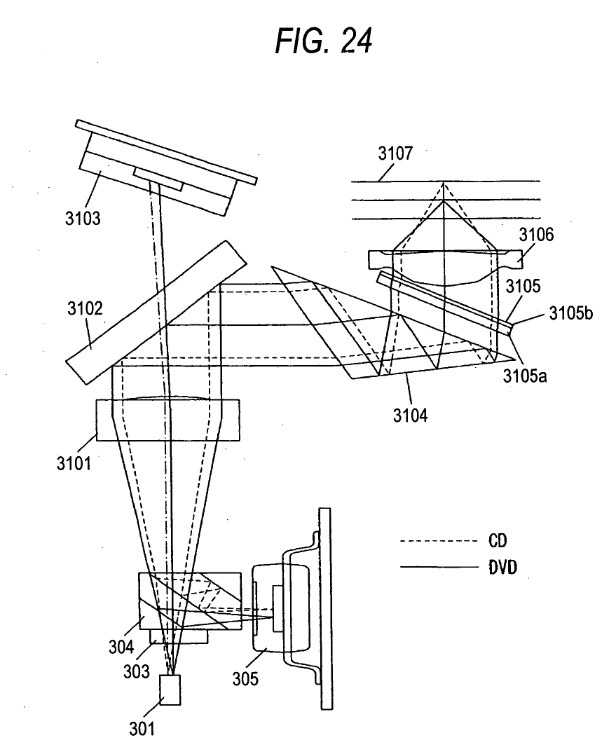

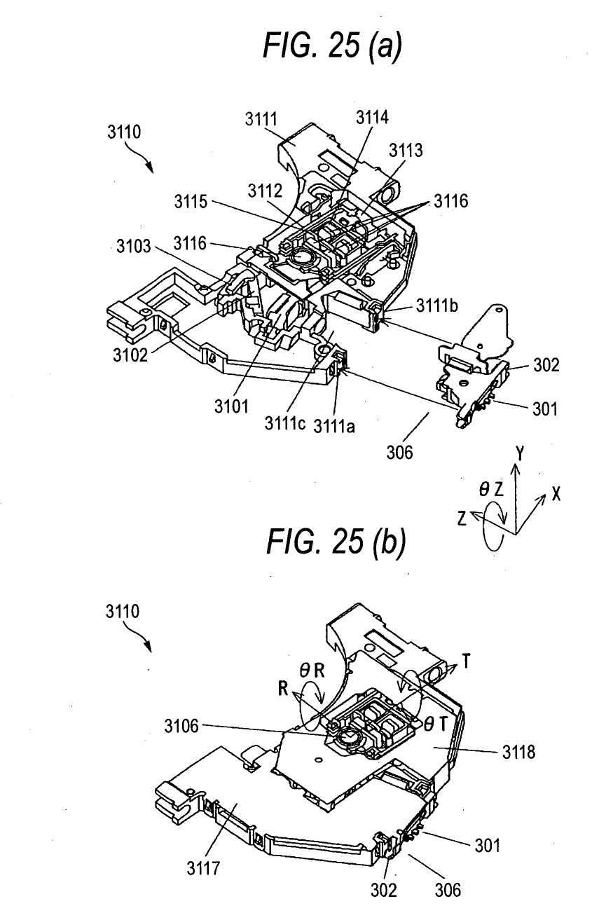

An optical pickup apparatus according to an embodiment mode 9 of the present invention will now be described with reference to drawings. FIG. 24 is a structural diagram for showing an optical system of the optical pickup apparatus according to the embodiment mode 9 of the present invention. FIG. 25(a) is an exploded structural diagram for indicating the optical pickup of this embodiment mode 9, and FIG. 25(b) is an assembled structural diagram for representing this optical pickup.

While the optical pickup of this embodiment mode 9 is equipped with the above-explained laser light source module 306 according to the embodiment mode 8, this optical pickup comprises the below-mentioned optical system. A laser light source 301, optical elements 303 and 304, and a light receiving unit 305 are the same as those of the embodiment mode 8, and therefore, explanations thereof will be utilized.

A collimator lens 3101, and an objective lens 3106 corresponding to a two-focal-point objective lens have been manufactured by employing either optical glass or optical plastic. Laser light emitted from a light emitting point and laser emitted from another light emitting point of the laser light source 3106 are converted by the collimator lens 3101 into substantially parallel laser light respectively, while the first-mentioned light emitting point emits the laser light having the wavelength “λ1” and the last-mentioned light emitting point emits the laser light having the wavelength “λ2”. Then, these substantially parallel light beams are collected by the objective lens 3106 in such a manner that these laser light beams are focused at positions of a recording plane of an optical disk 3107 in correspondence with the respective wavelengths thereof. In this embodiment mode 9, it should be understood that as the objective lens 3106, such a combined lens may be employed, namely, a lens manufactured by combining a collective lens with either a Fresnel lens or a hologram lens; a lens manufactured by providing an aperture limiting means on a DVD-purpose collective lens when a CD is reproduced; and the like. This objective lens 3106 may use such a lens capable of absorbing differences in thickness and aperture numbers of the optical disk 3107.

Abeam splitter 3102 is manufactured by either optical glass or optical plastic. A polarized light separating film is formed on a plane of the beam splitter 3102 on the side of the laser light source 301 in such a manner that this beam splitter 3102 reflects a major light component of the laser light emitted from any one of the light emitting points of the laser light source 301, penetrates therethrough a portion of this emitted laser light, and reflects a substantially entire light component of any laser light reflected from the recording plane of the optical disk 3107.

A raising prism 3104 corresponds to such a prism which is used to raise an optical axis which has been so for located within a plane substantially parallel to the plane of the optical disk 3107 at a substantially vertical direction with respect to the plane of the optical disk 3107, and may be alternatively formed as a mirror. A hologram element 3105 has be arranged by a polarizing hologram 3105a and a ¼ wavelength plate 3105b. The polarizing hologram 3105a has been manufactured by a material having a wavelength selecting characteristic which may be effected only to the light having the wavelength λ1. Also, as to the ¼ wavelength plate 3105b, both a refractive index and a thickness have been set in such a manner that this ¼ wavelength plate 3105b may be effected both to the wavelengths λ1 and λ2.

As to the optical disk 3107, there are CD, CD-ROM, CD-R/RW in a CD series, whereas there are DVDROM, DVD±R/RW, DVD-RAM in a DVD series. All of these optical disks can be recorded as well as reproduced except for reproduction-only media in the CD series and DVD series.

A fore light monitor 3103 corresponds to such a sensor which receives the light emitted from the light emitting point of the laser light source 301 and penetrated through the beam splitter 3102, and then which converts a light amount into an electric signal. This electric signal is supplied to a control circuit (not shown) which controls a drive circuit (not shown) the laser light source 301 in such a manner that a light amount of a collective spot collected on the optical disk 3107 becomes constant.

Next, an optical path will now be explained. Such a light corresponds to a P-polarized wave, which is emitted from the light emitting point of the laser light sources 301, which emits the laser light having the wavelength λ1 for the DVD purpose. This P-polarized wave passes through the optical element 303, and then, directly passes through the polarized light separating films 378 and 379 formed on inclined planes 375 and 376 of the optical element 304, and thereafter, is entered into the collimator lens 3101, since this laser light being the P-polarized wave. The entered laser light is converted into substantially parallel light by the collimator lens 3101, a major light component of this parallel light is reflected by the beam splitter 3102, and then, the reflected laser light is entered to the raising prism 3104. Furthermore, this entered reflection light passes through the hologram element 3105 and the object lens 3106, and then, is focused on the recording plane of the optical disk 3107. The laser light which partially penetrates the beam splitter 3102 is entered to the fore light monitor 3103, and this entered light is converted into an electric signal which is used in the light amount control operation.

Also, the polarizing direction of the light has been set in such a manner that when the light passes through the hologram element 3105, this light may pass therethrough without receiving the influence of the polarizing hologram 3105a, and this light is converted by the ¼ wavelength plate 3105b from the linearly polarized light to the circularly polarized light.

Light which is reflected from the recording plane of the optical disk 3107 passes through the objective lens 3106, the hologram element 3105, the raising prism 3104, the beam splitter 3102, and the collimator lens 3101, and thereafter, is entered to the optical element 304. When the light again passes through the hologram element 3105, this light is converted by the ¼ wavelength plate 3105b from the circularly polarized light into such a linearly polarized light which is positioned perpendicular to the linearly polarized light of the incoming optical path, namely S-polarized light. This S-polarized light is separated by the polarizing hologram 3105a into signal light components which correspond to the RF signal, the tracking error signal, the focusing error signal, and the like. In the beam splitter 3102, substantially all of the S-polarized waves are reflected.

Since the light entered to the optical element 304 corresponds to the S-polarized wave, this light passes through the polarized light separating film 379 which is provided on the inclined plane 376 within the optical element 304, and is reflected by the polarized light separating film 378 provided on the inclined plane 375, and thereafter, is entered to the photodetector of the light receiving sensor 381c. The respective signal light components which are separated by the polarizing hologram 3105a and is then entered to the photodetector of the light receiving sensor 381c are converted into various sorts of electric signals by this right receiving sensor 381c.

Such a light corresponds to a P-polarized wave, which is emitted from the light emitting point of the laser light source 301, which emits the laser light having the wavelength λ1 for the DVD purpose. This P-polarized wave is separated by the optical element 303 into three beams, and then, these 3 beams are entered to the optical element 304. The laser light directly passes through the polarized light separating films 378 and 379 formed on the inclined planes 375 and 376 of the optical element 304, and thereafter, is entered into the collimator lens 3101, since this laser light being the P-polarized wave. The entered laser light is converted into substantially parallel light by the collimator lens 3101, a major light component of this parallel light is reflected by the beam splitter 3102, and then, the reflected laser light is entered to the raising prison 3104. Furthermore, this entered reflection light passes through the hologram element 3105 and the object lens 3106, and then, is focused on the recording plane of the optical disk 3107. The laser light which partially penetrates the beam splitter 3102 is entered to the forelight monitor 3103, and this entered light is converted into an electric signal which is used in the light amount control operation.

Also, when the light passes through the hologram element 3105, this light may pass therethrough without receiving the influence of the polarizing hologram 3105a, and this light is converted by the ¼ wavelength plate 3105b from the linearly polarized light to the circularly polarized light.

Light which is reflected from the optical disk 3107 passes through the objective lens 3106, the hologram element 3105, the raising prism 3104, the beam splitter 3102, and the collimator lens 3101, and thereafter, is entered to the optical element 304. When the light again passes through the hologram element 3105, this light is converted by the ¼ wavelength plate 3105b from the circularly polarized light into such a linearly polarized light which is positioned perpendicular to the linearly polarized light of the incoming optical path, namely S-polarized light. This S-polarized light directly passes through the polarizing hologram 3105a, since the influence of the polarizing hologram 3105a is not received in this wavelength. Substantially all of the S-polarized waves are reflected from the beam splitter 3102.

Since the light entered to the optical element 304 corresponds to the S-polarized wave, this light is reflected by the polarized light separating film 379 which is provided on the inclined plane 376 within the optical element 304, and is separated by the hologram 380 provided on the inclined plane 377, and thereafter, this separated light is entered to the photodetector of the light receiving sensor 381c. This entered light is converted into various sorts of electric signals by the light receiving sensor 381c.

Next, a structure of the optical pickup 3110 will now be explained.

A carriage 3111 constitutes a skelton of the optical pickup 3110. Various sorts of optical components, and components which constitute this optical pickup 3110 are directly mounted on this carriage 3111, or are mounted via other components on this carriage 3111. The carriage 311 is manufacture by an alloy material such as a Zn alloy and an Mg alloy, or a hard resin material.

The objective lens 3106 has been movably held by a lens holding unit 3112. Although not shown in the drawing, the hologram element 3105 has also be held by the lens holding portion 3112. The lens holding unit 3112 has been movably supported by a supporting unit 3113 by using a suspension wire, or the like. The supporting unit 3113 has been fixed to the carriage 311 by way of an adhesive agent, or the like. Both a focus coil 3114 and a tracking coil 3115 have been provided in a through hole of the lens holding unit 3112. Also, a permanent magnet 3116 fixed on the supporting unit 3113 has been inserted into the through hole. The lens holding unit 3112 is moved by the permanent magnet 3116, the focus coil 3114, and the tracking coil 3115. In other words, since a predetermined current is supplied to the focus coil 3114, the lens holding unit 3112 is moved along the focusing direction. Similarly, since a predetermined current is supplied to the tracking coil 3115, the lens holding unit 3112 is moved along the tracking direction. The objective lens 3106 is controlled in this method in such a way that this objective lens 3106 is always located at a predetermined position of the optical disk 3107.

Also, the raising prism 3104 has been fixed on the carriage 3111 on the lower plane side of the objective lens 3106. Also, the collimator lens 3101, the beam splitter 3102, and the fore light monitor 3103 has been directly fixed, or has been fixed via other members to the carriage 3111. The laser light source 301 has been fixed via the coupling base 302 to the carriage 3111. Furthermore, the carriage 3111 has been covered by covers 3117 and 3118.

The carriage 3111 is equipped with a notch portion 3111c for storing the laser light source module 306, and abutting planes 3111b and 3111a which abut against the reference planes 331a and 332 of the coupling base 302. The laser light source module 306 is stored in the notch portion 3111c, and is mounted on the carriage 3111 of the optical pickup 3110 while the reference planes 331a and 332a abut against the abutting planes 3111b and 3111a.

Next, a description is made of a method for manufacturing the optical pickup 3110.

Both the carriage 3111 which has fixed at least the collimator lens 3101 and the laser light source module 306 are arranged at predetermined positioning of a manufacturing apparatus, and both the reference planes 331a and 332a of the coupling base 302 which constitutes the laser light source module 306 abut against the abutting planes 3111b and 3111a of the carriage 3111. A ultraviolet hardening adhesive agent has been previously coated on at least any one of the abutting planes 3111b, 3111a and the reference planes 331a, 332a. Similar to the manufacturing apparatus explained in the embodiment mode 8, a CCD camera, or the like has been mounted on this manufacturing apparatus, so that a light amount distribution of laser light can be grasped. While the light emitting point for emitting the laser light having the wavelength λ1 for the DVD purpose emits the laser light, a shift between a gravity position of the light amount distribution and the center of the collimator lens 3101 is calculated. The laser light source module 306 is moved along both an X-axis direction and a Y-axis direction of FIG. 25, and is adjusted in order that the center of the collimator lens 3101 is not shifted from the gravity position of the light amount distribution. It should be understood that the X axis, the Y axis, and a Z axis of FIG. 25 are identical to the X axis, the Y axis, and the Z axis of FIG. 18. As a consequence, the laser light having the wavelength λ1 passes through the center of the collimator lens 3101. Also, a projection of the center of the collimator lens 3101 to the laser light source 301 is located between the light emitting point for emitting the laser light having the wavelength λ1 and the light emitting point for emitting the laser light having the wavelength λ2. This implies that both the light emitting points are not present on the axis of the collimator lens 3101.

Next, while the light emitting point for projecting the laser light having the wavelength λ2 for the CD purpose emits the laser light, the laser light source module 306 is rotated along a direction of “θZ” shown in FIG. 25 so as to set the arranging direction of the three light beams separated by the optical element 303 to a predetermined direction. Finally, ultraviolet rays are irradiated so as to harden the ultrasonic hardening adhesive agent.

Next, the supporting unit 3113 is arranged at a predetermined position of the carriage 3111, and is arranged at a predetermined position of the manufacturing apparatus. Also, a CCD camera, or the like is mounted on this manufacturing apparatus, so that a light amount distribution of laser light can be grasped. The supporting unit 3113 has supported the lens holding unit 3112 which mounts the objective lens 3106 by way of a suspension wire. The lens holding unit 3112, the suspension wire, and the supporting unit 3113 are arranged in such a manner that these units are not contacted to the carriage 3111. The ultraviolet hardening adhesive agent is coated to bridge over the supporting unit 3113 and the carriage 3111.

While the light emitting point for projecting the laser light having the wavelength λ1 emits the laser light, the supporting unit 3113 is rotated along directions of “θR” and “θT” shown in FIG. 25 for adjustment purposes. An R axis of FIG. 25 corresponds to the radial direction of the optical disk 3107, and a T axis thereof corresponds to the tangential direction of the circumference of the optical disk 3107. Since the supporting unit 3113 is rotated/adjusted along the direction θR and the direction θT, the objective lens 3106 can be properly inclined with respect to the optical disk 3107.

Next, while the light emitting point for projecting the laser light having the wavelength λ1 emits the laser light, the supporting unit 3113 is moved along an R-axis direction in order that a gravity position of the light amount distribution along the R-axis direction is made coincident with the center of the objective lens 3106. In other words, as to the laser light having the wavelength λ1 of the optical pickup according to this embodiment mode 9, the gravity of the light amount distribution passes through both the center of the collimator lens 3101 and the center of the objective lens 3106, and further, the light emitting point for projecting the laser light having the wavelength λ1 is not located on the axis of the collimator lens 3101. Finally, ultraviolet rays are irradiated so as to harden the ultraviolet hardening adhesive agent. The reason why the supporting unit 3113 is moved in the above-described embodiment mode 9 is given as follows. That is, the influence given to the performance by which the information is recorded, or reproduced with respect to the optical disk 3107 is large. Therefore, the supporting unit 3113 is moved along the R-axis direction. Alternatively, the supporting unit 3113 may be moved along the T-axis direction. As a result, the performance may be furthermore improved by this movement along the T-axis direction. Also, if the influence given to the performance is reversed, then the supporting unit 3113 may be moved only along the T-axis direction.

Also, in the embodiment mode 9, the gravity position of the light amount distribution has been employed. Alternatively, similar to the embodiment mode 8, another index such as a position indicative of a maximum light amount of a light amount distribution may be employed. In this alternative case, in order to reduce the adverse influences caused by the fluctuations in the respective measuring points of the light amount distribution, it is desirable to calculate an approximate curve of the light amount distribution.

As previously explained, since the optical pickup 3110 of this embodiment mode 9 is equipped with the laser light source module 306 of the above-explained embodiment mode 8, the projection direction of the laser light having the wavelength λ1 for the DVD purpose can be stabilized, so that the performance capable of recording and reproducing the information with respect to the optical disk 306 can become stable. In addition, since the reference planes 331a and 332a of the coupling base 302 which constitutes the laser light source module 306 abut against the abutting planes 3111b and 3111a of the carriage 3111 of the optical pickup 3110, this performance can become further stable. Moreover, the slight shift of the projection direction is finally adjusted in the very fine mode by moving the objective lens 3106 along the R-axis direction, so that the projection direction of the laser light having the wavelength λ1 can be made substantially coincident with the center of the objective lens 3106.

Also, as to the laser light having the wavelength λ2 for the CD purpose, the light amounts of the laser light entered to the photo detectors of the light receiving unit 305 are balanced at the stage for manufacturing the laser light module 306. As a result, the performance of the optical pickup 3110 capable of recording and reproducing the information with respect to the optical disk 3107 for the CD purpose can also become stable.

### Embodiment Mode 10

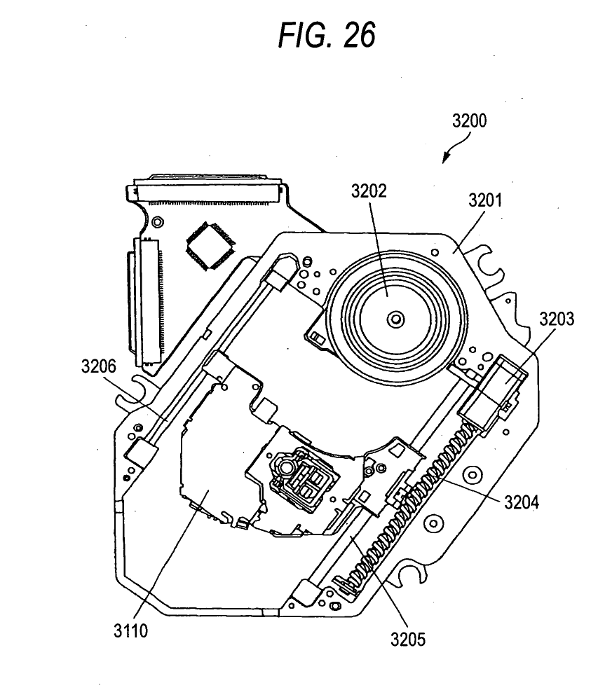

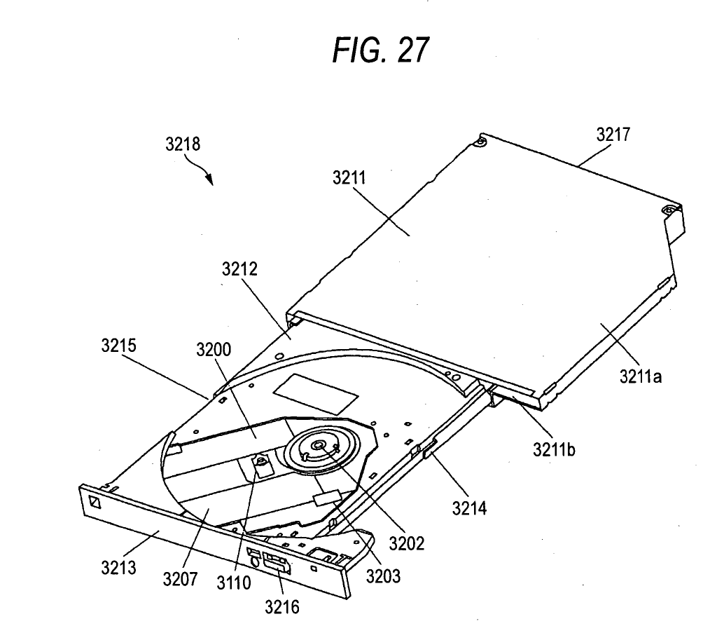

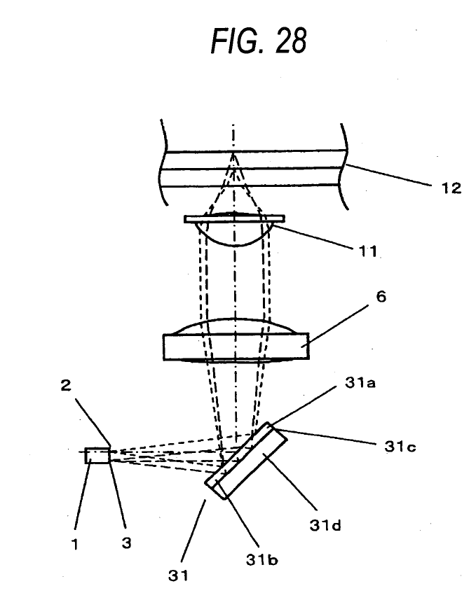

Referring now to drawings, an embodiment mode 10 of the present invention will be described. The embodiment mode 10 corresponds to an optical disk apparatus equipped with the above-described optical pickup of the embodiment mode 9. FIG. 26 is a structural diagram for indicating a driving mechanism of the optical disk apparatus of the embodiment mode 10. FIG. 27 is a structural diagram for showing the optical disk apparatus of the embodiment mode 10.

It should be understood that the driving mechanism for driving both the optical disk 3107 of the optical disk apparatus 3218 and the optical pickup 3110 will be referred to as an “optical pickup module 3200.” While a base 3201 constitutes a skelton of the optical pickup module 3200, the respective structural components are fixed on this base 3201 in a direct manner as well as an indirect manner.

A spindle motor 3202 equipped with a turn table which mounts thereon the optical disk 3107 is fixed on the base 3201. This spindle motor 3202 produces rotating drive force by which the optical disk 3107 is rotated.

A feed motor 3203 is fixed on the base 3201. This feed motor 3203 produces rotating drive force which is required to move the optical pickup 3110 between an inner peripheral portion and an outer peripheral portion of the optical disk 3107. As the feed motor, a stepper motor, a DC motor, and the like are used. While a spiral-shaped groove has been formed in a screw shaft 3204, this screw shaft 3204 is connected to the feed motor 3203 in a direct manner, or via several stages of gears. It should be noted that in this embodiment mode 10, the screw shaft 3204 is directly connected to the feed motor 3203. Guide shafts 3205 and 3206 are fixed via a supporting member to the base 3201 at both edges thereof. The guide shafts 3205 and 3206 movably support the optical pickup 3110. The optical pickup 3110 is equipped with a rack having a guide teeth which is meshed with the groove of the screw 3204. Since this rack converts the rotating drive force of the feed motor 3203 transferred to the screw shaft 3204 into linear drive force, the optical pickup 3110 can be moved between the inner peripheral portion and the outer peripheral portion of the optical disk 3107.

The optical pickup 3110 corresponds to such an optical pickup which has been explained in the embodiment mode 9. The optical pickup 3110 performs at least one of a recording operation and a reproducing operation as to information with respect to the optical disk 3107. To this end, the optical pickup 3110 projects laser light toward the optical disk 3107. In order that the laser light projected from the optical pickup 3110 is entered at a right angle with respect to the optical disk 3107, inclinations of the guide shafts 3205 and 3206 are adjusted by an adjusting mechanism which constitutes a supporting member.

An upper housing 3211a is combined with a lower housing 3211b, and these housings 3211a and 3211b are fixed with each other by using a screw, or the like, which constitute a housing 3211. A tray 3212 is provided in this housing 3211 in freely inserting/deriving manner. The tray 3212 arranges the optical pickup module 3200 on which a cover 3207 has been mounted from the lower plane side. While the cover 3207 has an opening, this opening may expose both a portion containing the objective lens 3106 of the optical pickup 3110 and the turn table of the spindle motor 3202. In the case of this embodiment mode 10, the opening also exposes the feed motor 3203. A bezel 3213 is provided at a front edge plane of the tray 3212, and when the tray 3212 has been stored into the housing 3211, the inserting/deriving port of the tray 3212 is blocked.

While an eject switch 3214 is provided with the bezel 3213, this eject switch 3214 is depressed, so that an engagement between the housing 3211 and the tray 3212 is released, and thus, this tray 3212 can be brought into the inserting/deriving condition with respect to the housing 3211. A rail 3215 and another rail 3216 are slidably mounted on both side portions of the tray 3212 and the housing 3211 respectively.

While circuit boards (not shown) are provided within the housing 3211 and the tray 3212, an IC of a signal processing system and a power supply circuit have been mounted. An external connector 3217 (not shown) is connected to power supply/signal lines which are provided in an electronic appliance such as a computer. Then, electric power is supplied via the external connector 3217 to the optical disk apparatus 3218, an electric signal supplied from an external unit is conducted to the optical disk apparatus 3218, or an electric signal produced in the optical disk apparatus 3218 is fed to an external electronic appliance, and the like.

As previously explained, the optical disk apparatus 3218 of this embodiment mode 10 has been equipped with the optical pickup 3110 explained in the above-described embodiment mode 9. The optical pickup 3110 of the embodiment mode 9 may comprise the stable performance also for the laser light system having the wavelength λ1 for the DVD purpose. As a consequence, while the optical disk apparatus 3218 of this embodiment mode 10 can realize the stable recording and reproducing performance with respect to the CD purpose, this optical disk apparatus 3218 can also realize the stable recording and reproducing performance with respect to the DVD purpose.

As previously explained, the optical pickup apparatus and the optical disk apparatus, according to the present invention, can record and reproduce information with respect to the CD series and the DVD series in higher double speeds with employment of the two-wavelength semiconductor laser light source, and also, can be properly employed in electronic appliances such as personal computes and notebook type computers.

What is claimed is:

1. An optical pickup apparatus, comprising:
a light source, in which a plurality of light emitting points having different wavelengths are provided;
a light receiving unit, receiving light reflected from an optical disk to produce an electric signal; and
an optical system, collecting light emitted from the respective light emitting points to the optical disk and conducting the light reflected from the optical disk to the light receiving unit;
wherein the optical system includes a filter which converts the light emitted from the respective light emitting points into a predetermined optical intensity distribution.

2. The optical pickup apparatus according to claim 1, wherein the filter is formed on a plane of an optical transmitting member which is not located opposite to the light emitting points; and
the filter reflects the light emitted from the light emitting point to incident the reflected light into the optical disk.

3. The optical pickup apparatus according to claim 2, wherein the filter is a beam splitter separating the light emitted from the light emitting point into light reflected from the beam splitter to be entered to the optical disk, and light penetrating the beam splitter to be entered to a control unit for controlling an amount of light emitted from the light emitting points.

4. The optical pickup apparatus according to claim 2, wherein the filter is comprised of:
a wavelength selective polarized light separating film which is formed on the plane of the optical transmitting member and becomes a predetermined reflectance factor in predetermined polarized light having a predetermined wavelength; and
a total reflecting film which is formed on a surface of the wavelength selective polarized light separating film in correspondence with the predetermined optical intensity distribution.

5. The optical pickup apparatus according to claim 4, wherein the total reflecting film is arranged such that the total reflecting film is not formed in the vicinity of an optical axis of the optical system.

6. The optical pickup apparatus according to claim 2, wherein the optical transmitting member comprises a plane on which the filter has been formed, and another plane which is located not parallel to the first-mentioned plane and opposite to the light emitting point.

7. The optical pickup apparatus according to claim 6, wherein the plane which is located opposite to the light emitting points is inclined in a direction along which astigmatism of light emitted from such a light emitting point at a position shifted from the optical axis of the optical system is made smaller than astigmatism occurred in such a case that the plane where the filter is formed is located parallel to the plane which is located opposite to the light emitting points.

8. The optical pickup apparatus according to claim 1, wherein the filter is arranged in such a manner that the filter penetrates therethrough the light emitted from the light emitting points, and enters the penetrated light to the optical disk.

9. The optical pickup apparatus according to claim 8, wherein a wavelength selective polarized light transmitting film which becomes a predetermined transmittance at a predetermined wavelength corresponding to the predetermined optical intensity distribution and in predetermined polarized light; and
a total transmitting film which is formed on the same plane as the wavelength selective polarized light transmitting film outside the wavelength selective polarized light transmitting film in a continuous manner.

10. The optical pickup apparatus according to claim 9, wherein the wavelength selective polarized light transmitting film is formed in the vicinity of the optical axis of the optical system.

11. The optical pickup apparatus according to claim 10, wherein while the optical system comprises a ¼ wavelength plate, the filter is moved in combination with an objective lens, and is formed on an optical component located on the side of the light source rather than the ¼ wavelength plate.

12. An optical disk apparatus, comprising:
the optical pickup apparatus according to claim 1;
a rotation drive unit, rotating an optical disk; and
a moving unit, approaching and separating the optical pickup apparatus with respect to the rotating drive unit.

13. An optical pickup apparatus, comprising:
a light source, in which a plurality of light emitting points are provided in proximity to each other;
a light receiving unit, for receiving light reflected from an optical disk to produce an electric signal;
a diffraction grating, which is provided between the light source and the light receiving unit, in which a plurality of parallel grooves for separating the light emitted from the light source into three light beams are formed in a direction along which the three light beams are arrayed at a very small angle with respect to a tangential direction of a circumference of the optical disk; and
an optical system provided between the diffraction grating and the optical disk, which collects the light emitted from the light source to the optical disk, and conducts the light reflected from the optical disk to the receiving unit;
wherein the diffraction grating has two regions in which phases between hills and valleys of the grooves are shifted, and a boundary between the two regions passes through a center of the light emitted from the light source and is set parallel to the tangential direction of the circumference of the optical disk.

14. The optical pickup apparatus as claimed in claim 13, wherein the shifts of the phases between the hills and valleys of the grooves are set to a half of the circumference.

15. The optical pickup apparatus as claimed in claim 13, wherein only as to such a light emitting point where a tracking error signal is produced only from one light, the diffraction grating has two regions in which phases between hills and valleys of the grooves are shifted, and a boundary between the two regions passes through a center of the light emitted from the light source and is set parallel to the tangential direction of the circumference of the optical disk.

16. An optical pickup comprising:
a laser light source module including,
a laser light source, in which a plurality of light emitting points for emitting laser light having different wavelengths are arranged in proximity to each other,
a light receiving sensor, for receiving the laser light to convert the received laser light into an electric signal,
an optical element, for conducting the laser light emitted from the laser light source to the optical disk, and for conducting the laser light reflected from the optical disk to the light receiving sensor,
a coupling base, for arranging thereon the laser light source, the light receiving sensor, and the optical element,
in the laser light source module, a direction directed by a center of a light amount distribution of light emitted from a predetermined light emitting point of the laser light source is set to a predetermined direction with respect to a reference of the coupling base,
a collimator lens for converting the laser light emitted from the respective light emitting points of the laser light source into substantially parallel light;
an objective lens for collecting the substantially parallel laser light converted by the collimator lens onto a recording plane of the optical disk; and
a carriage for arranging the collimator lens and the objective lens in a direct manner, or via another member; wherein:
the center of the light amount distribution of the light emitted from the predetermined light emitting point of the laser light source is made substantially coincident with a center of the collimator lens; and a center of a light amount distribution of the light which passes through the collimator lens and is emitted from the predetermined light emitting point is made substantially coincident with a center of the objective lens.

17. The optical pickup according to claim 16, wherein a projection of the center of the collimator lens to the laser light source is present between the predetermined light emitting point and a light emitting point except for the predetermined light emitting point.

18. The optical pickup according to claim 16, the center of the light amount distribution of the light corresponds to a gravity center of the light amount distribution of the light.

19. The optical pickup as claimed in claim 16, wherein the center of the light amount distribution of the light is made substantially coincident with the center of the objective lens in a radial direction of the optical disk.

20. The optical pickup as claimed in claim 16, wherein among the plurality of light emitting points for emitting the laser light having the different wavelengths, the predetermined light emitting point of the laser light source corresponds to such a light emitting point for emitting laser light having the shortest wavelength.

21. An optical disk apparatus, comprising:
the optical pickup apparatus according to claim 13;
a rotation drive unit, rotating an optical disk; and
a moving unit, approaching and separating the optical pickup apparatus with respect to the rotating drive unit.

22. An optical disk apparatus, comprising:
the optical pickup apparatus according to claim 16;
a rotation drive unit, rotating an optical disk; and
a moving unit, approaching and separating the optical pickup apparatus with respect to the rotating drive unit.
